(19) United States
(12) Patent Application Publication
(10) Pub. No.: US 2026/0074900 A1
(43) Pub. Date: Mar. 12, 2026

(54) MULTI-DEVICE DATA EXCHANGE ACCOUNT PROVISIONING

(71) Applicant: Apple Inc., Cupertino, CA (US)

(72) Inventors: Kartik Subramanian, Sunnyvale, CA (US); Rahul Narayan Singh, Santa Clara, CA (US); Yousuf H. Vaid, Fremont, CA (US); Anton K. Diederich, Mountain View, CA (US); Christian C. Flurscheim, Concord, CA (US); Timothy M. Skeen, San Francisco, CA (US); Sunil Nair, Fremont, CA (US)

(73) Assignee: Apple Inc., Cupertino, CA (US)

(21) Appl. No.: 19/264,615

(22) Filed: Jul. 9, 2025

Related U.S. Application Data
(60) Provisional application No. 63/693,663, filed on Sep. 11, 2024.

(51) Int. Cl. H04L 9/08; H04L 9/32

(52) U.S. Cl. CPC H04L 9/088; H04L 9/0894; H04L 9/3265

(57) ABSTRACT

Techniques are disclosed for provisioning a data exchange account to a user device. The user device can transmit a request for account provisioning data for a user account with a third-party service provider and then receive encrypted account provisioning data and an ephemeral public encryption key. The user device can then transmit device registration data to a server configured to decrypt the encrypted account provisioning data and register the user device with the third-party service provider. The user device can receive an encrypted data exchange account identifier and decrypting the encrypted data exchange account identifier.

### CROSS-REFERENCES TO OTHER APPLICATIONS

This application claims priority to U.S. Provisional Application No. 63/693,663, for “MULTI-DEVICE DATA EXCHANGE USING NFC PUSH INITIATION” filed on Sep. 11, 2024, which is herein incorporated by reference in its entirety for all purposes.

### BACKGROUND

User devices like smartphones can be used with a terminal device to initiate a data exchange between related computer systems to complete a transaction, grant access, or other actions. Near-field communication can be used as the communication medium between the user device and the terminal device. Data security and connectivity can influence whether credentials and other information are transmitted to the related computer systems from the terminal device or the user device. There is therefore a need for improved methods of initiating data exchanges between multiple devices.

### BRIEF SUMMARY

Embodiments of the present disclosure relate to techniques for initiating a data exchange between two backend computer systems with a near-field communication (NFC) exchange between a user device and a terminal device. More particularly, embodiments of the present disclosure provide methods, user devices, server devices, computer-readable media, and applications and application programming interfaces that allow for an NFC-initiated data exchange in which the user device initiates (“pushes”) and sends data exchange information authorizing the exchange to the backend systems/networks rather than the terminal device initiating (“pulling”) and sends transaction information, including identifiers and/or credentials from the user device, to the backend systems to authorize the exchange. A particular illustrative example of the above data exchanges are payment transactions initiated between a user device and a terminal device, which may be a merchant's point-of-sale (POS) device. In the pull model, the terminal device can prepare transaction information and then receive payment account information from, for example, a payment card or a smartphone. Such transactions typically use NFC. In the push model, the terminal device can instead present transaction information that can be obtained by the user device and subsequently transmitted to the backend system for processing the payment. Such push transactions are typically mediated using a quick response (QR) code that the user device can scan to obtain the transaction information. The techniques described herein provide methods to implement push model transactions via NFC between the terminal device and user device. In doing so, the security and privacy of the data exchange is improved because the transaction information from the terminal device is securely provided to the user device via NFC, and account information stored at the user device is securely transmitted from the user device to the backend systems without requiring the terminal device to relay the information.

One embodiment is directed to a method performed by a user device. The method includes establishing a near-field communication (NFC) connection with a terminal device and receiving a request from the terminal device using the NFC connection. The request can include a data exchange payload that ahs an entity identifier corresponding to an entity associated with the terminal device. The data exchange payload can characterize a data exchange between a first computing system associated with the entity and a second computing system associated with a data exchange account associated with the user device. The method also includes generating an encrypted data exchange payload in response to receiving the request. The encrypted data exchange payload can include the entity identifier and a data exchange account identifier corresponding to the data exchange account. The method also includes transmitting the encrypted data exchange payload to a server device. The server device can be configured to validate the encrypted data exchange payload using the data exchange account identifier. The method also includes receiving an indication that the data exchange was successfully completed from a third-party computer system.

Another embodiment is directed to a user device that includes one or more processors and one or more memories storing instructions that, when executed by the one or more processors, cause the user device to perform any of the methods described above.

Still another embodiment is directed to a non-transitory computer-readable medium storing computer-executable instructions that, when executed by one or more processors of a user device, cause the user device to perform any of the methods described above.

Another embodiment is directed to a method performed by a terminal device. The method can include transmitting a request for data exchange information associated with a data exchange account. The request can be transmitted to a first computer system of an entity associated with the terminal device. The method also includes receiving the data exchange information from the first computer system. The method also includes generating a data exchange payload using the data exchange information. The data exchange payload can include an entity identifier of the entity. The data exchange payload can characterize a data exchange between the first computer system and a second computer system associated with the data exchange account. The method also includes transmitting the data exchange payload to a user device using a near-field communication connection. The user device can be configured to both encrypt the data exchange payload to produce an encrypted data exchange payload send the encrypted data exchange payload to a third-party computer system to initiate the data exchange. The encrypted data exchange payload can include a data exchange account identifier payload and the entity identifier.

Another embodiment is directed to a terminal device that includes one or more processors and one or more memories storing instructions that, when executed by the one or more processors, cause the terminal device to perform the method described above.

Still another embodiment is directed to a non-transitory computer-readable medium storing computer-executable instructions that, when executed by one or more processors of a terminal device, cause the terminal device to perform the method described above.

Another embodiment is directed to a method performed by a server device. The method can include receiving an encrypted data exchange payload from a user device. The encrypted data exchange payload can include a data exchange account identifier associated with the user device. The method can also include validating the encrypted data exchange payload using the data exchange account identifier and based at least in part on successfully validating the encrypted data exchange payload, transmitting the encrypted data exchange payload to a third-party computer system.

Another embodiment is directed to a server device that includes one or more processors and one or more memories storing instructions that, when executed by the one or more processors, cause the server device to perform the method described above.

Still another embodiment is directed to a non-transitory computer-readable medium storing computer-executable instructions that, when executed by one or more processors of a server device, cause the server device to perform the method described above.

### BRIEF DESCRIPTION OF THE DRAWINGS

FIG. 1 illustrates a simplified flow chart and block diagram of a technique to initiate a data exchange using an NFC connection, according to some embodiments.

FIG. 2A illustrates a conventional NFC pull transaction initiation.

FIG. 2B illustrates a conventional push transaction initiated using a QR code.

FIG. 3 illustrates a push transaction initiated using an NFC connection, according to some embodiments.

FIG. 4 is a sequence diagram illustrating an example data flow between a user device and a terminal device when initiating a data exchange, according to some embodiments.

FIG. 5 is a sequence diagram illustrating another example data flow between one or more applications executing at a user device, a server device, and a third-party service provider for provisioning a data exchange account at the user device, according to some embodiments.

FIG. 6 illustrates data payloads transmitted from a terminal device to a user device and to a server device to initiate a data exchange, according to some embodiments.

FIG. 7 illustrates an example architecture of a computer system having multiple devices for initiating data exchanges, according to some embodiments.

FIG. 8 illustrates an example process for initiating a push model data exchange using a user device, according to some embodiments.

FIG. 9 illustrates an example process for preparing a push model data exchange at a terminal device, according to some embodiments.

FIG. 10 illustrates an example process for validating and relaying a push model data exchange payload from a user device by a server device, according to some embodiments.

FIG. 11 illustrates an example process for provisioning a data exchange account at a user device, according to some embodiments.

FIG. 12 illustrates an example process for provisioning a data exchange account using a server device to verify device keys generated by the user device, according to some embodiments.

FIGS. 13A and 13B illustrate methods of application processes, in accordance with some embodiments.

FIG. 13B illustrates a device for implementing an API, in accordance with some embodiments.

FIG. 13C illustrates a system for implementing an API, in accordance with some embodiments.

FIGS. 13D and 13E illustrate data flows related to API processes, in accordance with some embodiments.

### DETAILED DESCRIPTION

In the following description, various examples will be described. For purposes of explanation, specific configurations and details are set forth in order to provide a thorough understanding of the examples. However, it will also be apparent to one skilled in the art that the examples may be practiced without the specific details. Furthermore, well-known features may be omitted or simplified in order not to obscure the example being described.

Examples of the present disclosure are directed to, among other things, methods, systems, devices, computer-readable media, applications and application programming interfaces that enable a device, like a smartphone, to initiate a “push” model data exchange with another device, like a terminal device, and one or more backend computer systems and/or networks. A data exchange, as used herein, can refer to a particular transmission and/or reception of defined data between the user device, the other device, and the backend systems according to defined protocols and in which the backend computer systems and networks may be configured to perform additional operations to verify, validate, and complete the exchange. As described briefly above, the other device may be a terminal device configured to prepare a data exchange payload characterizing the data exchange. A user device (e.g., a smartphone) can initiate the data exchange and obtain the data exchange payload from the terminal device via an NFC connection with the terminal device. An application or an applet on the user device can then encrypt the data exchange payload and provide a data exchange account identifier and transmit the encrypted data exchange payload to a server device for validation and subsequently to a third-party system to effect the data exchange.

As a particular example, the data exchange may be a payment transaction that is initiated at a merchant's POS device. Conventionally (in the pull model), a user device may store payment account information and provide that information to the POS to initiate payment via NFC, after which the POS transmits the account information and payment information to their banking institution and/or a payments processing network to complete the transaction between the merchant's bank and a bank associated with the payment account. Instead, the POS device can prepare the payment information and transmit that information to the user device, after which the terminal device is not actively involved in the data exchange. The user device can then include the payment account identifier into the payload and cryptographically sign and/or encrypt the payment information. The user device can then initiate the backend transaction by sending the payment information to a payment processing network. To provide additional security, the user device can send the encrypted data exchange payload to a server device hosting a service associated with the user device that can validate the device signature before transmitting the data exchange payload to the payment processing network.

The techniques described herein provide a number of technical improvements to address a number of technical problems as compared to conventional systems and techniques. In the conventional pull model, the terminal device relays the payment authorization, including account identifiers, from the user device to the backend network. Although the account identifiers are typically tokenized, validating the token usually requires an intermediate step provided by a token service provider before the backend system can confirm the payment. By sending the payment information from the user device, the account information can be transmitted securely only to the backend system associated with the account, avoiding user information passing through the terminal device. By eliminating the intermediate token service, the backend system is improved by reducing the expenditure of computational and networking resources to detokenize the account information at the intermediary token service provider. In addition, NFC communication can allow for encryption of the data exchange payload between the terminal device and the user device, improving the security of the data.

Although the techniques described herein for data exchange make reference to the particular illustrative example of payment transactions, the technical benefit can be applied to other data exchange scenarios. A data exchange, as used herein, can refer to a particular transmission and/or reception of defined data between the user device or systems associated with the user device (e.g., backend systems associated with a user account tied to the user device) and the other computing device and in which the user device and/or computing device may be configured to perform additional operations to verify and/or validate the exchange. In the examples described briefly above, the other computing device may be a terminal device configured to process data exchanges with systems associated with the user device and may access, for example, additional computing devices or service providers over a separate network to verify, validate, or otherwise confirm the data exchanged with the user device. For example, the data exchange session can include the transmission of access credentials and the validation of those credential by the backend system before providing approval and access at the terminal device.

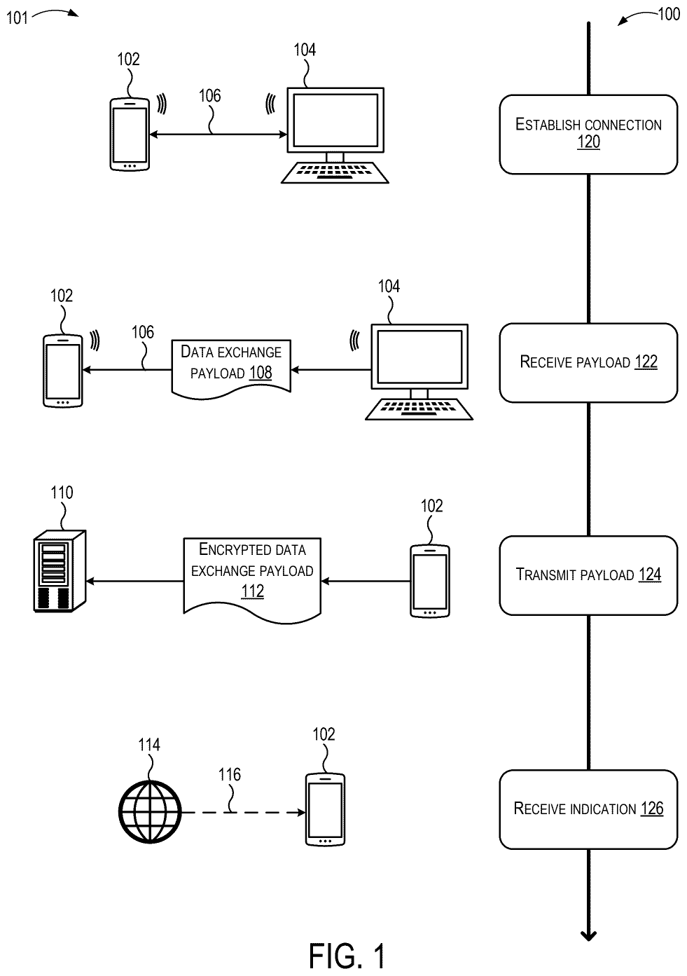

Turning now to the figures, FIG. 1 illustrates a simplified flow chart and block diagram of an example process 100 to initiate a data exchange using an NFC connection between a user device 102 and a terminal device 104, according to some embodiments. The diagram 101 includes a user device 102, a terminal device 104, and a server device 110, which may be examples of computer devices that are configured to communicate over one or more networks to perform data exchange operations, including transmitting/receiving data exchange payloads. The user device 102 is illustrated as a smartphone. In some embodiments, the user device 102 can be any suitable user device including smartphone, smartwatch, tablet, laptop computer, or other similar device that can execute an application or applet to communicate with the terminal device 104. In some examples, the user device 102 may include one or more applications which may include custom-built algorithms and other logic, code, or executable instructions, to enable performance of at least some of the techniques described herein. The user device 102 may also include storage media for storing computer-executable instructions (e.g., that make up the application) and other data described herein, including tokens and data exchange account information. The user device 102 may be operated by a user.

The terminal device 104 may be a suitable computing device for communicating with the user device 102 in a data exchange session. In some examples, the terminal device 104 may be a point of sale (POS) system that can communicate with the user device using near-field communication (NFC) for the exchange of information to effect a payment transaction. Beyond the use in payments, the terminal device 104 could be an access control terminal for providing access to various locations.

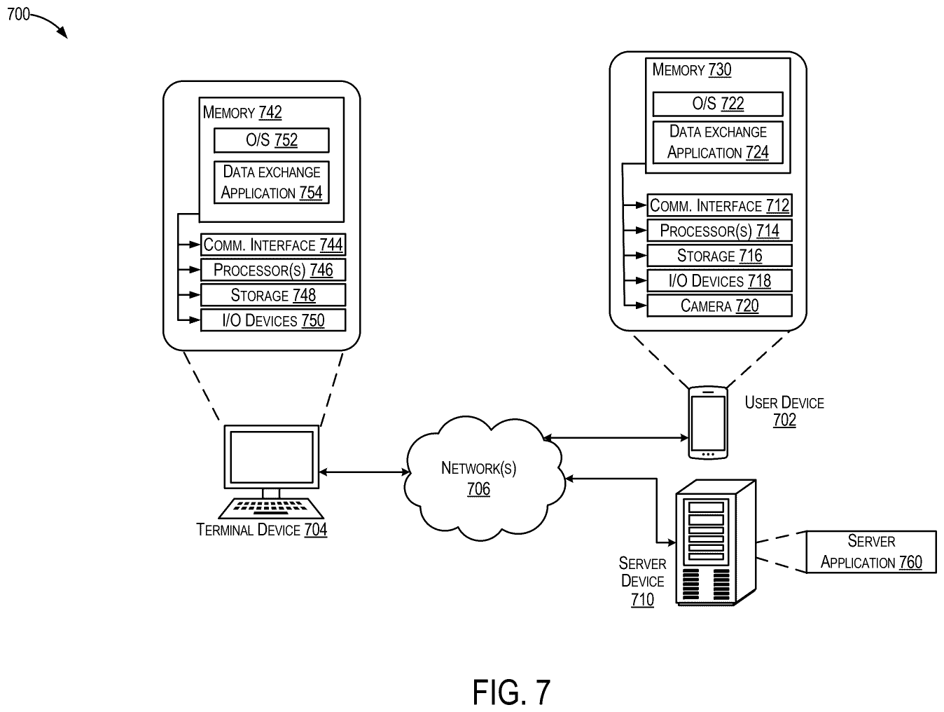

Similarly, the server device 110 may be any suitable computing device or arrangement of one or more computing devices that can be configured to perform the operations described herein and communicate with the user device 102 for performing data exchange operations. In some embodiments, the server device 110 can be one or more virtual machines implemented within a cloud computing or other hosted environment. The cloud computing environment may include provisioned computing resources like compute, storage, and networking. For example, the server device 110 can include cloud-based computing with associated storage for maintaining data exchange account information and association information for associating the data exchange accounts with one or more third-party service providers. Additional details about exemplary user devices, server devices, and terminal devices like user device 102, terminal device 104, and server device 110 are described below with respect to FIG. 6.

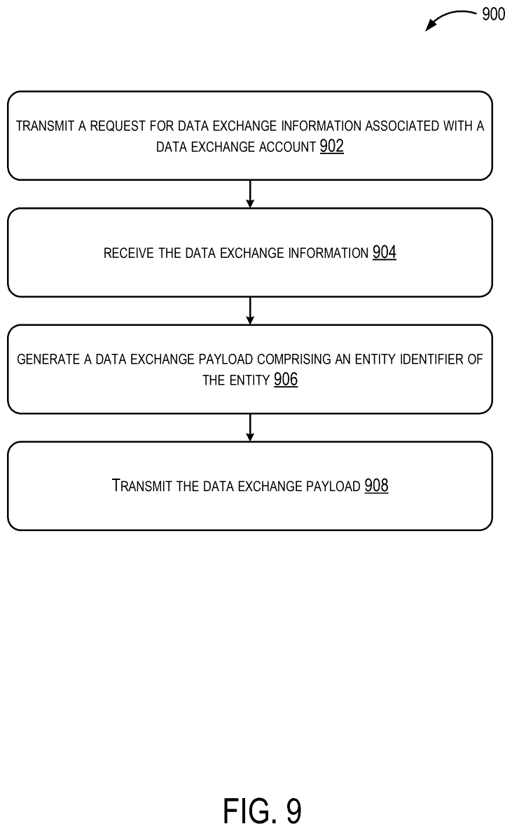

The process 100, and any other process described herein (e.g., processes 800, 900, 1000, 1100, and 1200 of FIGS. 8-12, respectively) are illustrated as logical flow diagrams, each operation of which represents a sequence of operations that can be implemented in hardware, computer instructions, or a combination thereof. In the context of computer instructions, the operations may represent computer-executable instructions stored on one or more non-transitory computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, some, any, or all of the processes described herein may be performed under the control of one or more computer systems configured with specific executable instructions and may be implemented as code (e.g., executable instructions, one or more computer programs, or one or more applications) executing collectively on one or more processors, by hardware, or combinations thereof. As noted above, the code may be stored on a non-transitory computer-readable storage medium, for example, in the form of a computer program including a plurality of instructions executable by one or more processors.

The process 100 can begin at block 120 with the user device 102 establishing an NFC connection 106 with the terminal device 104. For example, the terminal device 104 can present a payment transaction completion option on a screen, prompting the user to initiate a payment with the user device 102. By bringing the user device 102 in proximity with the terminal device 104, the user device 102 and terminal device 104 can establish the NFC connection 106 using NFC antennas and associated communication components on each device. The terminal device 104 may have generated a data exchange payload (e.g., data exchange payload 108) prior to the user device 102 establishing the NFC connection 106. For example, the details of a payment needed to complete a transaction as well as an identifier for the entity associated with the terminal device 104 can be included in the data exchange payload. Because an NFC connection 106 may be used to support payments using the conventional pull model used with payment cards (e.g., EMV2 transactions) and smartphone-based payments associated with payment cards, the terminal device 104 can be configured to identify a push model transaction method. For example, a user may have an account with a real time payments (RTP) service provider that operates using push model transactions. The terminal device 104 can then be configured to prepare the data exchange payload with an identification of the corresponding payment method to the user's account. In some embodiments, the user may select the account of the RTP service provider, so that the user device 102 can communicate the selection to the terminal device 104 over the NFC connection 106 once established. In other embodiments, the user device 102 can automatically determine a push model transaction account like an RTP service provider account based on account information maintained by the user device 102.

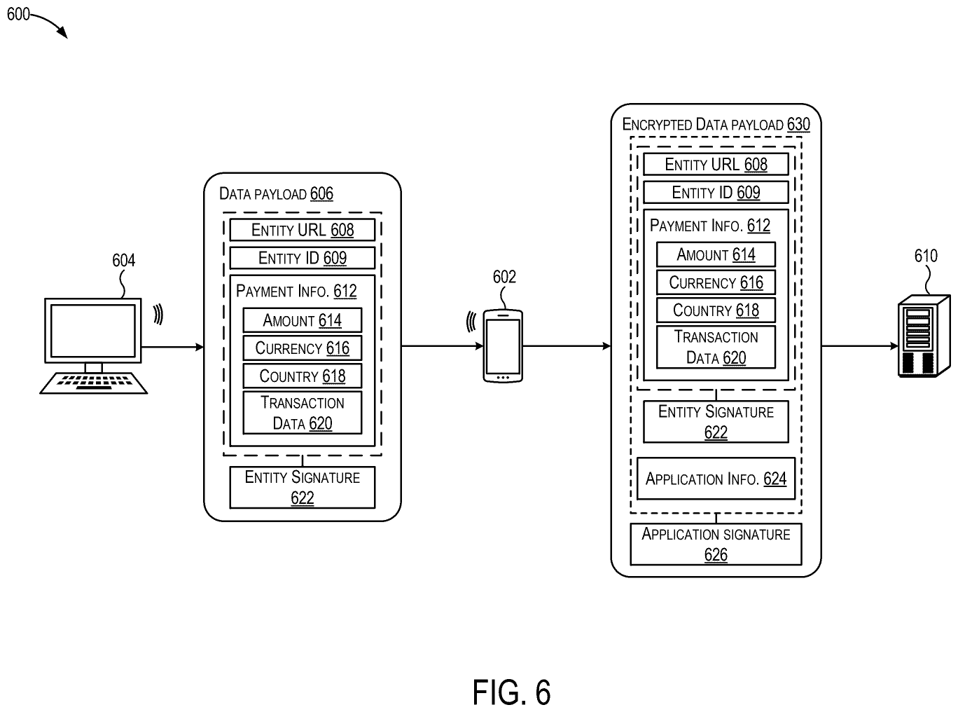

At block 122, once the NFC connection 106 has been established, the terminal device 104 can transmit, and the user device 102 can receive, a data exchange payload 108. The data exchange payload 108 can include information usable to complete a data exchange between computer systems over a third-party computer network. For example, the data exchange can be a financial transaction over an RTP network provided by an RTP service provider. The computer systems can be computer systems of financial institutions associated with the terminal device 104 and the user device 102, for instance a merchant's bank and a user's bank. The data exchange payload 108 can then include identifiers for the merchant (e.g., an entity associated with the terminal device 104), payment information including amount, currency, country of the transaction, and payment information. In comparison with a pull model payment (e.g., using a payment card), once the terminal device 104 has delivered the data exchange payload 108 to the user device 102, the payment (e.g., the data exchange) will be initiated by the user device 102. Additional details about the information included in the data exchange payload 108 are described below with respect to FIG. 5.

At block 124, the user device 102 can transmit an encrypted data exchange payload 112 to a server device 110. The server device 110 may be associated with the user device 102. For example, the server device 110 may host a service that coordinates data exchange accounts with the user device 102 and can be used to verify and/or validate that transactions initiated from the user device 102 actually originate from the user device 102. The user device 102 can generate the encrypted data exchange payload 112 by including information associated with the application or applet executing on the user device 102 in the data exchange payload 108 and then cryptographically signing the data exchange payload 108 and then encrypting the data exchange payload 108.

Once the server device 110 has received the encrypted data exchange payload 112, the server device 110 can verify the signature. If the signature is valid, the server device 110 can transmit the encrypted data exchange payload 112 to a third-party computer system 114.

At block 126, the user device 102 can receive an indication 116 from the third-party computer system 114 that the data exchange characterized by the data exchange payload 108 and the encrypted data exchange payload 112 was completed successfully. The indication 116 may be received over a network connection with the user device 102, including a cellular network or a wireless network. The third-party computer system 114 can include a third-party computer network that is configured to process transactions between additional computer systems. Continuing the payment transaction example from above, the third-party computer system 114 can be a RTP payment provider's computer system and associated network. The third-party computer system 114 can then facilitate a data exchange between a computer system of a bank associated with the terminal device 104 (e.g., the merchant's bank) and a bank associated with the user device 102 (e.g., the user's bank).

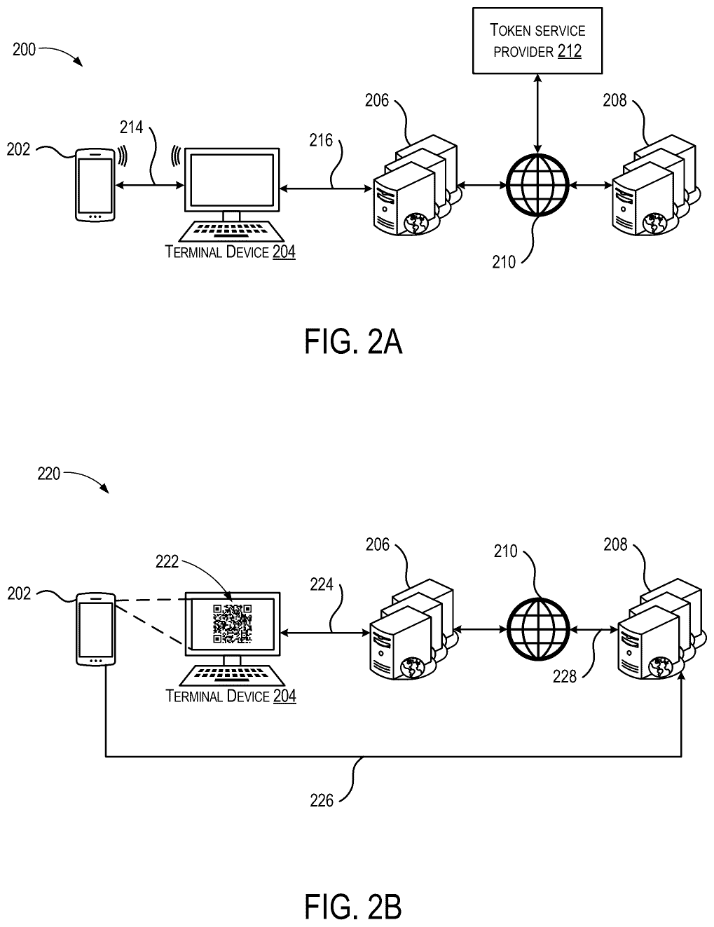

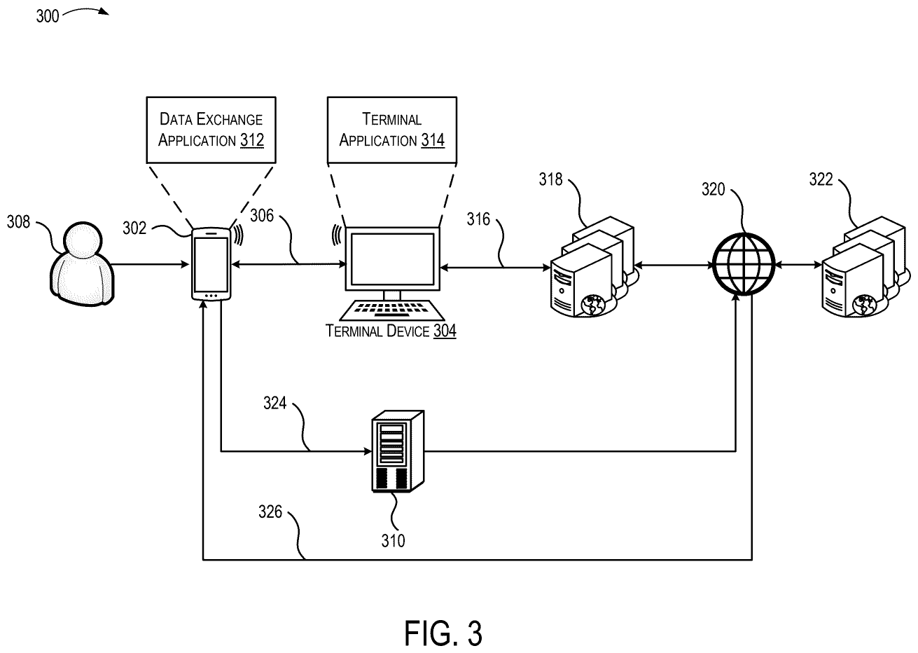

FIG. 2A illustrates a system 200 for a conventional NFC pull transaction initiation. As described briefly above, in the pull model, a terminal device (e.g., terminal device 204) can prepare transaction information and then receive payment account information from a user device (e.g., user device 202). The user device and terminal device can communicate using an NFC connection 214. Once the terminal device 204 has obtained the account information, the terminal device 204 can transmit the account information and other transaction information (e.g., payment information) as a payload 216 to an entity 206 associated with the terminal device 204. For example, the entity 206 can be a bank or financial institution (and computer systems thereof) associated with a merchant. Such pull model transactions are typical of EMV transactions using payment cards like credit and debit cards processed with a payments processing network. The account information can include a tokenized account identifier that corresponds to an account of the user device 202.

The data exchange in the pull model can be an exchange of information between a first computer system of the entity 206 and a second computer system of a second entity 208. The information can be financial information to resolve a payment characterized by the payload. For the entity 206 to complete the data exchange, the payload can be transmitted to a third-party computer network 210 to mediate the data exchange. Because the account identifier is tokenized, the third-party computer network 210 can transmit the tokenized account identifier to a token service provider 212 to resolve the corresponding account identifier and provide the account identifier to the third-party computer network 210. The third-party computer network 210 can then provide the transaction information in the payload to the second computer system of the second entity 208 along with the account identifier. The second entity 208 can authenticate the payload and account identifier and perform the data exchange with the entity 206 using the third-party computer network 210. The entity 206 can then provide an indication to the terminal device 204 that the data exchange was completed.

FIG. 2B illustrates a system 220 for a conventional push transaction initiated using a QR code 222. In the push model, the terminal device 204 can present transaction information that can be obtained by the user device 202 and subsequently transmitted to a computer system associated with the second entity 208. For example, the second entity 208 may be a bank associated with a payment account of the user device. The user device 202 can scan the QR code 222 to obtain the transaction information. The transaction information can include payment information, including an identifier for an entity 206 associated with the terminal device 204. Once the user device 202 has obtained the transaction information, the user device 202 can include an account identifier to create a payload and transmit the payload 226 to the second entity 208. The second entity 208 can use the payload, including the identifier for the entity 206, to transmit a request 228 to a third-party computer network 210 to perform the data exchange. The third-party computer network 210 can then exchange the data with the entity 206. The entity 206 can then provide an indication 224 to the terminal device 204 that the data exchange was completed.

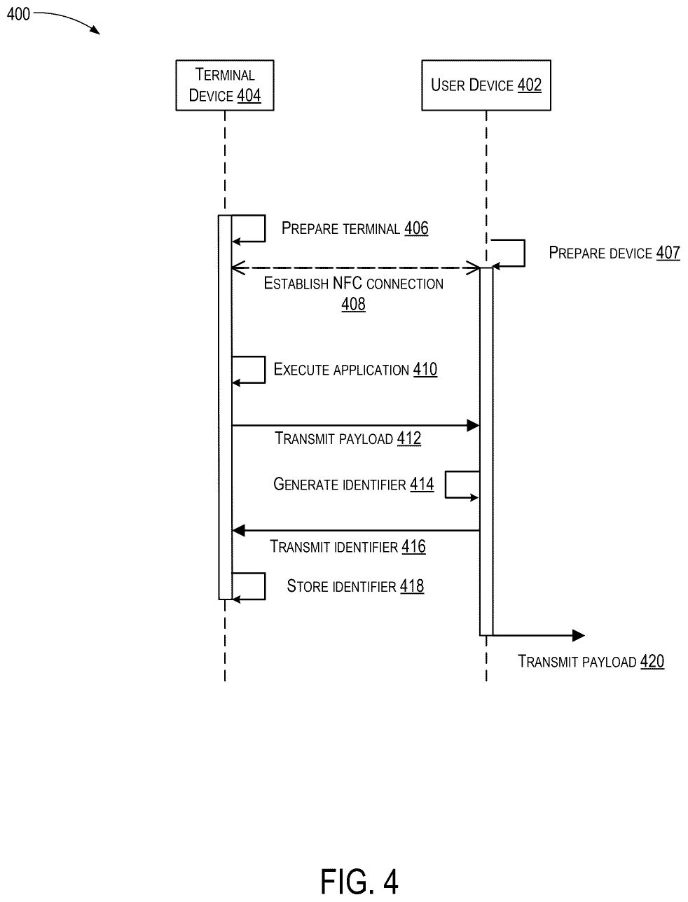

FIG. 3 illustrates a system 300 for a push transaction initiated using an NFC connection, according to some embodiments. The system 300 can include a user device 302, a terminal device 304, a server device 310, and backend computer systems associated with a first entity 318, a second entity 322, and a third-party computer network 320. The user device 302, the terminal device 304, and the server device 310 may be examples of user device 102, terminal device 104, and server device 110, respectively, described above with respect to FIG. 1.

As depicted in FIG. 3, the user device 302 may execute a data exchange application 312. The data exchange application 312 can be configured to communicate with a terminal device 304 via NFC connection 306 as part of initiating a transaction. For example, the data exchange application 312 may be a wallet application or a payment application executing on the user device 302. In some embodiments, the data exchange application 312 may be an applet executing on a secure component of the user device 302. The secure component may include one or more processing components (e.g., chips) configured to execute instructions for performing operations of the data exchange application. For example, the secure component can perform encryption operations, generating cryptographic signatures, storing and maintaining tokens and other account identifiers, and the like.

The terminal device 304 may execute a terminal application 314. The terminal application 314 may be different from data exchange application 312 that executes on the user device 302. The terminal application 314 may be configured to prepare transaction information into a data exchange payload that can be transmitted to the user device 302 from the terminal device 304. For example, the terminal device 304 can be a POS device of a merchant, so that the terminal application 314 is a payment application that generates payment information that can be used to complete a payment transaction between the first entity 318 and the second entity 322. The data exchange payload can include information identifying the entity 318 (or another entity associated with entity 318 like a merchant operating the terminal device 304), and information characterizing the data exchange. For the example where the data exchange is a payment transaction, the data exchange payload can include payment information like the amount, the type of currency, and the country in which the transaction occurs.

As part of preparing a data exchange payload, the terminal device 304 can request transaction information from the first entity 318 over a network connection 316. For example, the terminal application 314 can request transaction information from a bank associated with the terminal device 304 that specifies that a particular payment type will be accepted for a payment. The requested transaction information can, for instance, identify a real-time payments (RTP) service provider that can complete a payment transaction with the bank.

The user device 302 and the terminal device 304 can establish an NFC connection 306. For example, the user device 302 can be brought into proximity with the terminal device 304 to establish the NFC connection 306. Once the NFC connection 306 has been established, the terminal application 314 at the terminal device 304 can transmit the data exchange payload to the user device 302 over the NFC connection 306.

Once the user device 302 has obtained the data exchange payload, the data exchange application 312 can generate an encrypted data exchange payload that further includes an identifier for a data exchange account maintained by the user device 302. For example, the account identifier may be an identifier for a service provider providing real time payments processing between different banks or bank accounts for which a push model transaction is suitable. The selection of the identifier for the data exchange account can be made in several ways. In some embodiments, the terminal device 304 can be preconfigured with a selection of a particular service provider for the data exchange. For example, a merchant can input a selection to the terminal device 304 that determines the service provider for a particular RTP service provider. When a user 308 places the user device 302 in proximity to the terminal device 304 to initiate the payment transaction, the data exchange application 312 at the user device 302 can determine the identifier for an account that corresponds to the RPT service provider selected at the terminal device 304. In this example, the data exchange payload can include information identifying the RTP service provider that the data exchange application 312 can use to determine the corresponding RTP account maintained by the data exchange application 312.

In some embodiments, the user device 302 can be configured to select a particular account prior to or during the NFC connection 306. For example, a user can select a particular RTP account on the user device 302 when “tapping” the user device 302 at the terminal device 304 to establish the NFC connection 306. In another example, the data exchange application 312 can be configured to default to the RTP account for payments initiated over NFC, so that a push model transaction is initiated without input from users at either the user device 302 or the terminal device 304. In this example, the user device 302 and terminal device 304 can communicate information related to the selection of the RTP account using the NFC connection 306 to initiate the transaction. If the RTP service provider for the default account at the user device 302 is accepted by the entity 318, then the transaction can be conducted as a push model transaction. If the RTP service provider for the default account at the user device 302 is not accepted by the entity 318, then the transaction can be conducted as a conventional pull model transaction as described with respect to FIG. 2A.

The encrypted data exchange payload can also be signed by the data exchange application 312. Once signed, the encrypted data exchange payload can be transmitted to the server device 310 over a network connection 324. The network connection 324 can be a network connection over one or more networks that allow communication between the user device 302 and the server device 310. For example, for a smartphone as the user device 302, the network connection 324 can be a connection over a cellular network or wireless network to the server device 310.

As described previously, the server device 310 can any suitable computing device or arrangement of one or more computing devices that can be configured to perform the operations described herein and communicate with the user device 302 for performing data exchange operations. In some embodiments, the server device 310 can be one or more virtual machines implemented within a cloud computing or other hosted environment. The server device 310 can host services of a service provider associated with the user device 302 and/or the data exchange application 312. For example, the server device 310 may host a payments service that is configured to operate in conjunction with the data exchange application 312 to provision data exchange accounts (e.g., payment accounts) at the user device 302.

The server device 310 can validate the encrypted data exchange payload received from the user device 302. For example, the server device 310 can verify that the signature applied to the encrypted data exchange payload by the data exchange application 312 corresponds to user device 302. Once the encrypted data exchange payload has been validated, the encrypted data exchange payload can be transmitted to the third-party computer network 320. If the encrypted data exchange payload is not successfully validated, the server device 310 may abort the data exchange transaction.

The third-party computer network 320 can include one or more computer systems that are configured to perform operations to effect a data exchange between the first entity 318 and the second entity 322. For example, the third-party computer network 320 may be a payment processing network that can transmit payment information between a first bank (e.g., first entity 318) and a second bank (e.g., the second entity 322). The third-party computer network 320 may be a computer network of an RTP service provider. The third-party computer network 320 can decrypt the encrypted data exchange payload and use the transaction information to initiate a data exchange between the first entity 318 and the second entity 322. For example, an RTP service provider can use the payment information to deduct a payment amount from the second entity 322 and transfer the information about that deduction to the first entity 318 to credit an account at the first entity 318. Advantageously, because the user device 302 and the server device 310 communicate directly with the third-party computer network 320 with the appropriate transaction information in the encrypted data exchange payload to authorize the corresponding data exchange, there is no need for an intermediate step in which tokenized account information is detokenized to obtain an account identifier to complete the transaction.

Once the data exchange is completed, the third-party computer network 320 can transmit an indication 326 to the user device 302 that the data exchange was successfully completed. Similarly, the first entity 318 can transmit an indication to the terminal device 304 that the data exchange was completed.

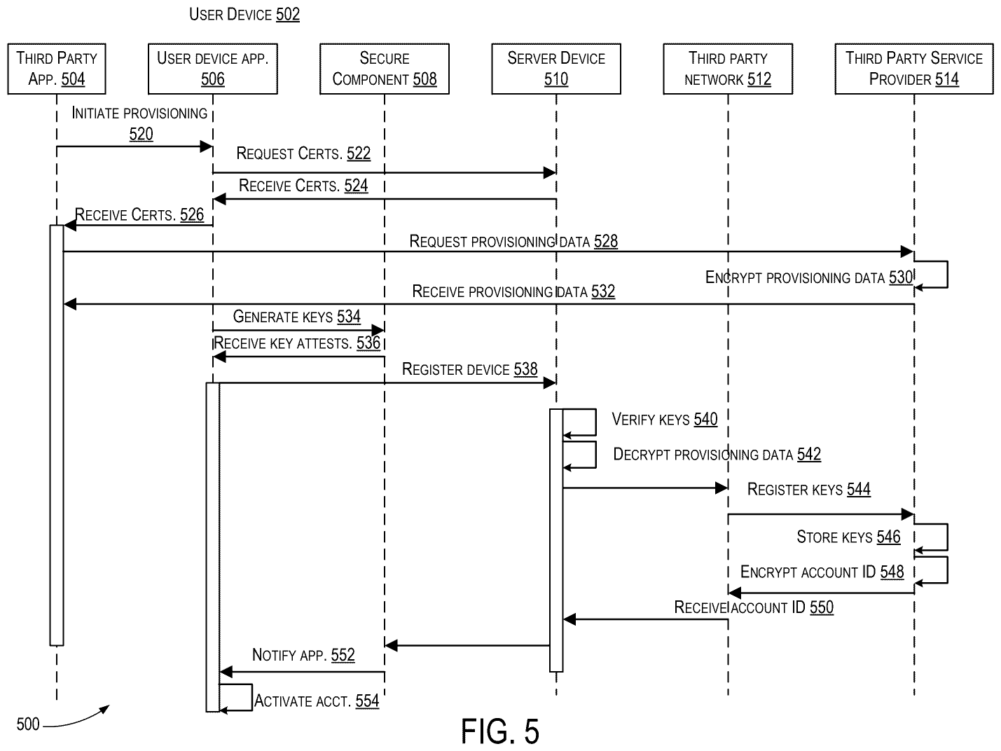

FIG. 4 is a sequence diagram illustrating an example data flow 400 between a user device 402 and a terminal device 404 when initiating a data exchange, according to some embodiments. The data flow 400 can occur in a system implementing a push model data exchange, for example the system 300 of FIG. 3. The system can include the user device 402 and the terminal device 404, which may be examples of user device 302 and terminal device 304 of FIG. 3, respectively. The user device 402 can execute a data exchange application (e.g., data exchange application 312 of FIG. 3) configured to perform operations described herein at the user device 402. Similarly, the terminal device 404 can execute a terminal application (e.g., terminal application 314 of FIG. 3) configured to perform operations described herein at the terminal device 404.

In data flow 400, the terminal device 404 can prepare the terminal 406. Preparing the terminal can include receiving input at the terminal device 404 to select a RTP method or service provider. For example, during a payment at a POS, a user (e.g., a cashier) can select a particular RTP service provider to use when a customer completes the payment transaction. Preparing the terminal 406 can include additional operations (not shown) in which the terminal device 404 requests and subsequently receives transaction information from an entity (e.g., entity 318 of FIG. 3) to prepare the terminal device for the data exchange operations. For example, the terminal device 404 can communicate with a computer system of a bank associated with the merchant operating the terminal device 404 to receive information corresponding to a particular RTP service provider that can be used in a subsequent payment transaction at the terminal device 404. In some embodiments, the user device 402 can be prepared 407. For example, a user (e.g., customer) can select the particular RTP service provider to use to complete a payment transaction, rather than the merchant at the terminal device 404.

After the terminal device 404 or the user device 402 have been prepared, the user device 402 can establish an NFC connection 408 with the terminal device 404. The NFC connection can be established by bringing the user device 402 into proximity of the terminal device 404 (e.g., “tapping” an NFC antenna of the user device 402 near an NFC antenna of the terminal device 404). Over the NFC connection, the user device 402 and the terminal device 404 can communicate the selection of the corresponding payment account type (e.g., the RTP service provider).

The terminal device 404 can then execute an application 410. The application can be the terminal application. In some embodiments, the terminal application may be configured for the particular data exchange method determined during the preparation operations 406, 407. For example, the terminal application may be an application configured for the specific RTP service provider selected at the user device 402 or terminal device 404. In some embodiments, the terminal device 404 may be configured to execute a different application for each different data exchange method that may be used to complete a data exchange transaction. For example, the terminal device 404 may support two different RTP service providers. Based on the preparation of the terminal device 404 (e.g., cashier selects one RTP service), the terminal device 404 can execute the terminal application corresponding to the selected RTP service.

The terminal device 404 can transmit 412 a data exchange payload to the user device. The data exchange payload can include an entity identifier associated with the terminal device 404. For example, the data exchange payload can include a merchant identifier for a merchant operating the terminal device 404. The data exchange payload can also include a uniform resource identifier (e.g., a uniform resource locator (URL)) for the entity and transaction information that characterizes the data exchange. For example, if the data exchange is a payment transaction, the data exchange payload can include payment information like price, currency, country, and the like. In some examples, the data exchange payload and its transmission from the terminal device 404 to the user device 402 may be compliant with one or more standards including ISO 14443-4. Advantageously in some embodiments, the data exchange payload can be transmitted in a single transmission from the terminal device 404, limiting additional negotiations and data transactions between the terminal device 404 and the user device 402. For example, an NFC data exchange format (NDEF) tag message may be transmitted for a first portion of data, and then a second NDEF tag message may be transmitted for a second portion of data, requiring multiple acknowledgments and requests from the user device to the terminal device to obtain a complete payload.

Once the user device 402 has the data exchange payload, the user device can generate 414 an identifier corresponding to the transaction and then transmit 416 the identifier to the terminal device 404. For example, the user device can create a unique identifier corresponding to the data exchange. The unique identifier can be used by the terminal device 404 for subsequent identification of the data exchange. The terminal device 404 can then store 418 the identifier.

Finally, the user device 402 can prepare the data exchange payload. The user device 402 can encrypt the data exchange payload to produce an encrypted data exchange payload. The user device 402 can include a device identifier or an account identifier in the encrypted data exchange payload. The user device 402 can transmit 420 the encrypted data exchange payload to another device (e.g., server device 310 of FIG. 3).

FIG. 5 is a sequence diagram illustrating another example data flow 500 between one or more applications executing at a user device 502, a server device 510, and a third-party service provider 514 for provisioning a data exchange account at the user device 502, according to some embodiments. The data flow 500 can occur in a system implementing a push model data exchange, for example the system 300 of FIG. 3. The system can include the user device 502 and the server device 510, which may be examples of user device 302 and server device 310 of FIG. 3, respectively. The user device 502 can execute a data exchange application 506 (an example of data exchange application 312 of FIG. 3) configured to perform operations described herein at the user device 502. The user device 502 can also execute a third-party application 504 configured to perform operations described herein for communicating with and obtaining data from a third-party service provider 514. For example, the third-party application 504 can be a user device application for providing account access to an RTP account provided by a RTP provider (e.g., third-party service provider 514). A third-party network 512 can be a computer network configured to allow network communication between the user device 502 and the third party service provider 514. For example, the third-party network 512 can be a RTP processing network. In some examples, the third-party network 512 can allow communication between a user device and more than one different third-party service providers. The user device 502 can also include a secure component 508. As described briefly above with respect to FIG. 3, the secure component may include one or more processing components configured to execute instructions for performing encryption operations, generating cryptographic signatures, storing and maintaining tokens and other account identifiers, as well as the operations described below with respect to data flow 500.

In data flow 500, the third-party application 504 can initiate 520 a provisioning process for a data exchange account at the user device 502. Provisioning the data exchange account can include operations for activating the data exchange account for use at the user device 502 using the data exchange application 506 at the user device 502 as well as configuring data exchange account data for use in data exchange transactions. In particular, the provisioning process exemplified by data flow 500 can occur in such a way as to preserve data privacy for account information that is generated and exchanged by applications at the user device 502 and the third-party service provider 514 while establishing and/or maintaining a chain of trust between the user device 502, the third-party service provider 514, and the server device 510. Advantageously, the operations of data flow 500 can allow the user device 502 to obtain a data exchange account identifier without the server device 510 (which is associated with user device 502 and usable to verify the authenticity of data generated by the user device 502) being able to separately access, store, or use the data exchange account identifier. Initiating 520 the provisioning process can include the third-party application 504 receiving user input at the user device 502 confirming the provisioning process. For example, a user may provide input at the user device 502 to add a data exchange account of the third-party application 504/third-party service provider 514 to the data exchange application 506.

After the provisioning process has been initiated, the data exchange application 506 can request 522 and receive 524 one or more certificates from the server device 510. The certificates may provide associated public encryption keys for the server device 510 as well as a chain of trust for those keys based on certificate authorities. The third-party application 504 can receive 526 the certificates from the data exchange application 506. In addition to the certificates, the server device 510 may provide a token (e.g., a nonce) to the data exchange application 506 that is later usable by the server device 510 to help verify data received by the server device 510 from the user device 502. The data exchange application 506 can use the secure component 508 to sign the token and provide the token and the token signature to the third-party application 504.

The third-party application 504 can request 528 provisioning data 528 from the third-party service provider 514. The request can include the certificates obtained from the server device 510. The request can also contain the signed token. In response to the request, the third-party service provider 514 can generate the provisioning data. The provisioning data can include information including an account name, an account identifier, and an identifier for the third-party service provider 514. The account identifier may be usable to associate the account with a user, but can be different than the data exchange account identifier generated later and securely transmitted to the user device 502 to provision the data exchange account with the user device 502.

The third-party service provider 514 can encrypt 530 the provisioning data. The third-party service provider 514 can generate an ephemeral key pair including an ephemeral public key and an ephemeral private key and use the ephemeral private key to encrypt the provisioning data. In some examples, the ephemeral private key can be used in conjunction with the public keys from the certificates to derive a shared key to encrypt the provisioning data. The encrypted provisioning data can include the signed token received as part of the request. The third-party service provider 514 can also obtain a certificate for its public key (different from the ephemeral the public key generated to encrypt the provisioning data). The third-party application 504 can then receive 532 the encrypted provisioning data, the ephemeral public key, and the public key certificate from the third-party service provider 514.

The data exchange application 506 can generate 534 device key pairs in conjunction with the secure component 508 that can be used for both encryption/decryption at the device and for generating signatures. The secure component 508 can store the device key pairs as well as sign the device public keys using a stored root certificate authority certificate to create public key attestations. For example, the root certificate authority certificate can be a controlling authority security domain certificate. The data exchange application 506 can receive 536 the public key attestations as well as the root certificate authority certificate from the secure component 508.

The data exchange application 506 can then register 538 the user device 502 with the third-party service provider 514 by transmitting the device public keys and attestations, the root certificate authority certificate, the encrypted provisioning data, and the ephemeral public key to the server device 510. The server device 510 can subsequently verify 540 the device keys. The server device 510 can verify the root certificate authority certificate by confirming the root certificate authority with the chain of trust known to the server device 510. With a verified, root certificate authority certificate, the server device 510 can verify the device public keys using the key attestations.

Once the device keys have been verified, the server device 510 can decrypt 542 the encrypted provisioning data using the ephemeral public key. Since the provisioning data includes the (signed) token originally generated by the server device 510, the server device 510 can verify the token to confirm the validity of the provisioning data. The server device 510 can then register 544 the user device 502 keys by transmitting the provisioning data, including the account identifier, the third-party service provider identifier, the device keys and attestations, and the root certificate authority certificate to the third-party network 512. The third-party network 512 can use the third-party service provider identifier to select the third-party service provider 514 and transmit the provisioning data to the third-party service provider 514.

The third-party service provider 514 can store 546 the device keys associated with the data exchange account using the account identifier. The third-party service provider 514 can then generate and encrypt a data exchange account identifier. For example, the data exchange account identifier can be a virtual payment address for the data exchange account. The data exchange account identifier can be different from the account identifier transmitted with the provisioning data. The third-party service provider 514 can encrypt 548 the data exchange account identifier with a shared encryption key derived using the device public encryption key and the private key of the third-party service provider 514. The private key of the third-party service provider 514 can be the corresponding private encryption key of the public encryption key sent from the third-party service provider 514 to the third-party application 504 in operation 532. Decrypting the data exchange account identifier can then require both the public key for the third-party service provider 514 and the device private key for the user device 502 (stored in secure component 508). Because the server device 510 does not have both of these keys, the server device 510 is unable to decrypt the data exchange account identifier.

The server device 510 can receive 550 the encrypted data exchange account identifier (via the third-party network 512). Subsequently, the secure component 508 can receive and store the encrypted data exchange account identifier. The secure component 508 can decrypt the data exchange account identifier since it has access to the device private key and the public key of the third-party service provider 514. The data exchange account identifier can be used by the user device 502 to initiate push model data exchange transactions.

The secure component 508 can notify 552 the data exchange application 506 that the provisioning is complete. In response to the notification, the data exchange application 506 can activate 554 the data exchange account for use in push model data exchange transaction initiated via NFC.

FIG. 6 illustrates a system 600 in which data payloads are transmitted from a terminal device 604 to a user device 602 and to a server device 610 to initiate a data exchange, according to some embodiments. The system 600 can include the user device 602, terminal device 604, and server device 610, which can be examples of user device 302, terminal device 304, and server device 310 of FIG. 3, respectively.

As depicted in FIG. 6, the terminal device 604 and the user device 602 can transmit/receive a data exchange payload 606 via an NFC connection (e.g., NFC connection 306 of FIG. 3). The data exchange payload 606 can include entity uniform resource locator (URL) 608, entity identifier 609, and payment information 612. The entity URL 608 can specify a network address reachable over a network connection (e.g., the Internet) with an entity associated with the terminal device 604. For example, the entity URL 608 can be a web address for a merchant operating the terminal device 604. The entity URL 608 may also be usable to connect to a computer system associated with the entity. For example, the entity URL 608 may be used to determine a connection to a bank hosting an account for the merchant and can be used when completing a payment transaction. Similarly, the entity identifier 609 may be a unique identifier corresponding to an entity associated with the terminal device 604 and can be used to when completing a data exchange with the entity.

The payment information 612 can include an amount 614 (e.g., R$3.65), a currency 616 (e.g., Brazilian reais, U.S. dollars, etc., identified by a currency code), a country 618 (e.g., a country code like BR, US, etc.), and transaction data 620. The transaction data 620 can include additional information about the data exchange transaction.

The data exchange payload 606 can be signed by the terminal device 604. The entity signature 622 can be appended to the data exchange payload 606. The entity signature 622 may be generated by the terminal device 604 using a key maintained by the terminal device 604.

The user device 602 can use the data payload 606 to generate an encrypted data exchange payload 630. The encrypted data exchange payload 630 can include all of the information from the data exchange payload 606 and additional information including application information 624. The application information 624 can include an account identifier or other information corresponding to an account maintained by the data exchange application at the user device 602. For example, the application information 624 can include an identifier for an RTP account available at the user device 602. The user device 602 can sign the information of the data exchange payload 606 and the additional application information 624 to produce an application signature 626 that is appended to the encrypted data payload 630. The encrypted data payload 630 can then be encrypted and transmitted to server device 610.

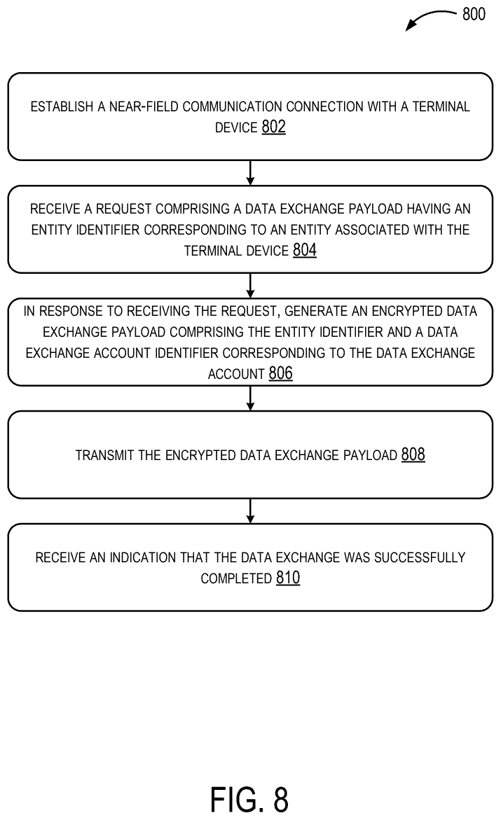

FIG. 7 illustrates an example architecture of a computer system 700 having multiple devices for initiating data exchanges, according to some embodiments. The system 700 includes a user device 702 (e.g., a mobile device, a smart phone, or other suitable computing device), a terminal device 704, a server device 710, and one or more network(s) 706. The user device 702, terminal device 704, and server device 710 may be examples of similarly named devices described herein, including user device 302, terminal device 304, and server device 310 of FIG. 3, respectively. The server device 710 can be one or more remote computing devices, including cloud devices. Each of these elements depicted in FIG. 7 may be similar to one or more elements depicted in other figures described herein. In some embodiments, at least some elements of system 700 may be used to perform data exchange operations in a data exchange session. The network(s) 706 may include any one or a combination of many different types of networks, such as cable networks, the Internet, wireless networks, cellular networks, and other private and/or public networks. The system 700 can also connect to a third-party computer network (not shown) that can perform the data exchange between a computer system of a first entity and a computer system of a second entity.

As described herein, the user device 702 can have at least one memory 730, a communications interface 712, one or more processing units (or processor(s)) 714, a storage 716, and one or more input/output (“I/O”) device(s) 718, and a secure element 720. The processor(s) 714 may be implemented as appropriate in hardware, computer-executable instructions, firmware or combinations thereof. Computer-executable instruction or firmware implementations of the processor(s) 714 may include computer-executable or machine executable instructions written in any suitable programming language to perform the various functions described. The I/O device(s) 718 can include displays, monitors, touch screens, mouse, keyboard, or other I/O device. The secure element 720 may be a secure component for storing cryptographically secure data associated with data exchange accounts. For example, the secure element 720 may be a secure portion of the storage 716 (e.g., an enclave) or a storage on dedicated hardware module (e.g., a hardware security module, a trusted platform module, etc.).

The memory 730 may store program instructions that are loadable and executable on the processor(s) 714, as well as data generated during the execution of these programs, transaction information, data exchange account information, data exchange payloads, and the like. Depending on the configuration and type of user device 702, the memory 730 may be volatile (such as random access memory (“RAM”)) or non-volatile (such as read-only memory (“ROM”), flash memory, etc.). In some implementations, the memory 730 may include multiple different types of memory, such as static random access memory (“SRAM”), dynamic random access memory (“DRAM”) or ROM. The user device 702 may also include additional storage 716, such as either removable storage or non-removable storage including, but not limited to, magnetic storage, optical disks, and/or tape storage. The disk drives and their associated computer-readable media may provide non-volatile storage of computer-readable instructions, data structures, program components, and other data for the computing devices. In some embodiments, the storage 716 may be utilized to store data contents received from one or more other devices (e.g., server device 710).

The memory 730 may include an operating system (O/S) 722 and one or more application programs, software components, or services for implementing the features disclosed herein, including a data exchange application 724. The data exchange application 724 may be configured to communicate with the terminal device 704 using an NFC connection) for exchanging data related to a transaction (e.g., a data exchange payload 606 of FIG. 6). The data exchange application 724 can be configured to maintain data exchange account information for one or more data exchange accounts associated with the user device 702. For example, the data exchange application 724 may be a virtual wallet storing account information that identifies payment methods (e.g., credit cards, bank cards, etc.) as well as RTP methods usable during a data exchange session with the terminal device 704. The data exchange application 724 can generate and send encrypted data exchange payloads to server device 710 (e.g., via communications interface 712). Similarly, the data exchange application 724 can transmit data (e.g., a selection of an RTP service) to the terminal device 704 via communications interface 712.

The user device 702 may also contain a communications interface 712 that allows the user device 702 to communicate with the terminal device 704, another computing device or server including server device 710, a third-party computer network, or other devices on the network(s) 706. The communications interface 712 can include a near-field communication (NFC) interface. The user device 702 may also include I/O device(s) 718, such as for enabling connection with a keyboard, a mouse, a pen, a voice input device, a touch input device, a display, speakers, a printer, etc.

Terminal device 704 can be a computing device configured to perform operations of data exchange session with a user device, including user device 702. In some embodiments, the terminal device can be a point of sale (POS) terminal configured for processing payment transactions in a push model with the user device 702. The terminal device 704 can include a memory 742, one or more processor(s) 746, I/O devices 750, and at least one storage unit 748. As with the processor(s) 714 of user device 702, the processor(s) 746 may be implemented as appropriate in hardware, computer-executable instructions, software, firmware, or combinations thereof. Computer-executable instruction, software, or firmware implementations of the processor(s) 746 may include computer-executable or machine-executable instructions written in any suitable programming language to perform the various functions described. The memory 742 may store program instructions that are loadable and executable on the processor(s) 746, as well as data generated during the execution of these programs. Depending on the configuration and type of memory included in the terminal device 704, the memory 742 may be volatile (such as RAM) and/or non-volatile (such as read-only memory (“ROM”), flash memory, or other memory). In some embodiments, the storage 748 may include one or more databases, data structures, data stores, or the like for storing and/or retaining information associated with data transactions. The storage 748 may include data stores for storing transaction identifiers and entity information like entity identifiers and URLs (e.g., entity URL 608 and entity identifier 609 of FIG. 6).

The memory 742 may include an operating system (O/S) 752 and one or more application programs, components, or services for implementing the features disclosed herein, including terminal application 754. The terminal application 754 may be configured to generate a data exchange payload (e.g., data exchange payload 606 of FIG. 6) and transmit the data exchange payload to the user device 702 in response to establishing an NFC connection with the user device 702.

As with the user device 702, the terminal device 704 may contain a communications interface 744 that allows the terminal device 704 to communicate with user device 702, a stored database, another computing device or server, or third-party computer networks. The communications interface 744 can include an NFC interface. The terminal device 704 may also include I/O device(s) 750, such as for enabling connection with a keyboard, a mouse, a pen, a voice input device, a touch input device, a display, speakers, a printer, etc.

Turning now to server device 710 in more detail, the server device 710 can be any suitable type of computing system including, but not limited to, a laptop computer, a desktop computer, a mobile phone, a smartphone, a server computer, etc. In some embodiments, the server device 710 is executed by one or more virtual machines implemented within a cloud computing or other hosted environment. The cloud computing environment may include provisioned computing resources like compute, storage, and networking. The server device 710 can communicate with the user device 702 via the network(s) 706 or other network connections. The server device 710 may be configured to implement the functionality described herein as part of a distributed computing environment. The server device 710 can execute a server application 760 that can be configured to perform operations of a data exchange process described herein.

For example, server application 760 can be configured to validate an encrypted data exchange payload sent from the user device 702.

FIG. 8 illustrates an example process 800 for initiating a push model data exchange using a user device, according to some embodiments. The process 800 may be performed by an application (e.g., data exchange application 312 of FIG. 3). Some of the operations described with respect to process 800 may be similar to operations described above with respect to data flow 400 of FIG. 4.

Process 800 may begin at block 802, with the application establishing a near-field communication (NFC) connection with a terminal device. For example, the user device hosting the application may be brought near the terminal device to initiate the data exchange session using an NFC interface.

At block 804, the application can receive a request from the terminal device using the NFC connection. The request can include a data exchange payload that has an entity identifier corresponding to an entity associated with the terminal device. For example, the entity may be a merchant operating the terminal device. The data exchange payload can characterize a data exchange between a first computing system associated with the entity and a second computing system associated with a data exchange account associated with the user device. For example, the data exchange can be a payment transaction between a computing system hosting a bank account for the merchant and a computing system hosting a bank account for a user of the user device. The data exchange account may be an account with a service provider for real time payment transactions. In some embodiments, the application can be a virtual wallet application. The data exchange payload can include transaction information including an entity identifier, an entity URL, a payment amount, a currency, a country code, and other payment information, as described above with respect to FIG. 5.

At block 806, the application can generate an encrypted data exchange payload in response to receiving the request. The encrypted data exchange payload can include the entity identifier and a data exchange account identifier corresponding to the data exchange account. For example, the application can retrieve a data exchange account identifier for a real time payment account maintained at a secure component of the user device and include that account identifier in the encrypted data exchange payload. The application can then sign and encrypt the payload to generate the encrypted data exchange payload.

As discussed above, in some embodiments the data exchange account can be determined based on a preconfigured selection of the data exchange account at the terminal device. For example, a merchant can input a selection to the terminal device that determines the service provider for a particular RTP service. When a user places the user device in proximity to the terminal device to initiate the payment transaction, the application can determine the identifier for an account that corresponds to the RPT service provider selected at the terminal device 304. In this example, the data exchange payload can include information identifying the RTP service provider that the application can use to determine the corresponding RTP account maintained by the application.

In some embodiments, the data exchange account can be determined based on a user selection of the data exchange account at the user device. For example, a user can select a particular RTP account on the user device when “tapping” the user device at the terminal device to establish the NFC connection. In another example, the application can be configured to default to the RTP account for payments initiated over NFC, so that a push model transaction is initiated without input from users at either the user device or the terminal device. In some embodiments, the data exchange account can be one of a plurality of data exchange accounts maintained by the application at the user device.

In some embodiments, the application can generate a request identifier in response to receiving the request. The request identifier can uniquely identify the data exchange. The application can transmit the request identifier to the terminal device using the NFC connection. The terminal device can store the request identifier for future use.

At block 808, the application can transmit the encrypted data exchange payload to a server device. The server device can be configured to validate the encrypted data exchange payload using the data exchange account identifier. For example, the server device can verify the signature of the encrypted data exchange payload to verify that the encrypted data exchange payload was generated by the user device.

At block 810, the application can receive an indication that the data exchange was successfully completed. For example, a third-party computer network (e.g., third-party computer network 320 of FIG. 3) can complete the data exchange between the first computer system associated with the entity and the second computer system associated with the second entity. Once the data exchange has been completed, the third-party computer network can send an indication to the user device indicating the successful completion of the data exchange.

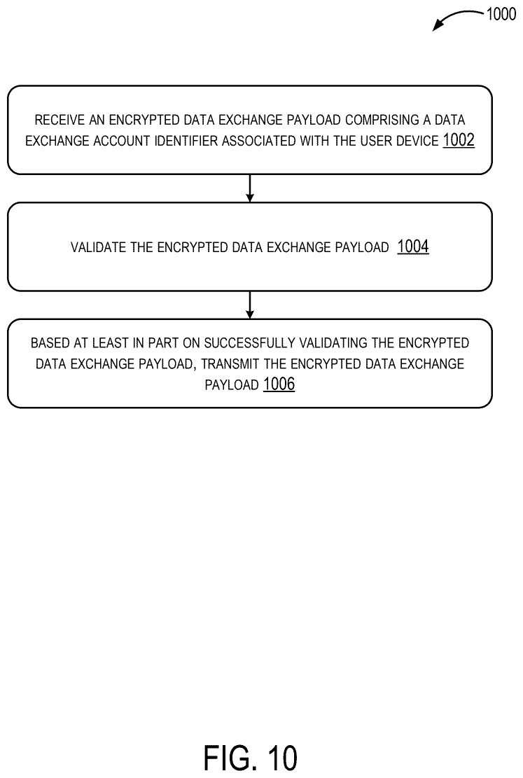

FIG. 9 illustrates an example process 900 for preparing a push model data exchange at a terminal device, according to some embodiments. The process 900 may be performed by an application (e.g., terminal application 314 of FIG. 3). Some of the operations described with respect to process 900 may be similar to operations described above with respect to data flow 400 of FIG. 4.

The process 900 can begin at block 902 with the application transmitting a request for data exchange information to a first computer system of an entity associated with the terminal device. The entity may be a merchant or a bank associated with a merchant that operates the terminal device. The first computer system can then be a computer system hosting an account for the merchant. The first computer system can be associated with a data exchange account. For example, the data exchange may be a real time payment transaction conducted by an RTP service provider. The data exchange account may be an account associated with the merchant and hosted by the first computer system for making and receiving real time payments with the RTP service provider. The data exchange information can include information identifying the RTP service provider. In some embodiments, transmitting the request for data exchange information occurs in response to a selection of the data exchange account at the terminal device. For example, if the merchant selects a particular RTP service provider for completing a payment at a POS terminal, then the POS terminal can connect to the first computer system to retrieve information about the associated RTP account associated with the merchant. The RTP service may itself by hosted by a third-party computer network.

At block 904, the application can receive the data exchange information from the first computer system. In some embodiments, the application can receive input at the terminal device selecting a particular data exchange account to use for the data exchange.

At block 906, the application can generate a data exchange payload using the data exchange information. The data exchange payload can include an entity identifier of the entity. For example, the data exchange payload can include a merchant identifier for the merchant operating the terminal device. The data exchange payload can characterize a data exchange between the first computer system and a second computer system associated with the data exchange account. For example, the data exchange can be a RTP transaction between a bank account of the merchant hosted by the first computer system and a bank account of a customer hosted by the second computer system. In some embodiments, the data exchange payload can include transaction data.

At block 908, the application can transmit the data exchange payload to a user device using a near-field communication connection. The user device can be configured to both encrypt the data exchange payload to produce an encrypted data exchange payload and send the encrypted data exchange payload to a third-party computer system to initiate the data exchange. The encrypted data exchange payload can include a data exchange account identifier and the entity identifier. For example, the encrypted data exchange payload can include the merchant identifier for the merchant and an account identifier provided by an application executing at the user device (e.g., data exchange application 312 of FIG. 3). In some embodiments, the NFC connection is established by the user device in proximity with the terminal device. In some embodiments, the third-party computer system can be an RTP processing network.

In some embodiments, the application can receive an indication that the data exchange was successfully completed from the first computer system. For example, once the third-party computer network has successfully processed a real time payment, the first computer system can provide an indication to the terminal device that the real time payment was received at the merchant's account.

In some embodiments, the application can receive a request identifier corresponding to the data exchange from the user device. The request identifier can be received in response to transmitting the data exchange payload to the user device.

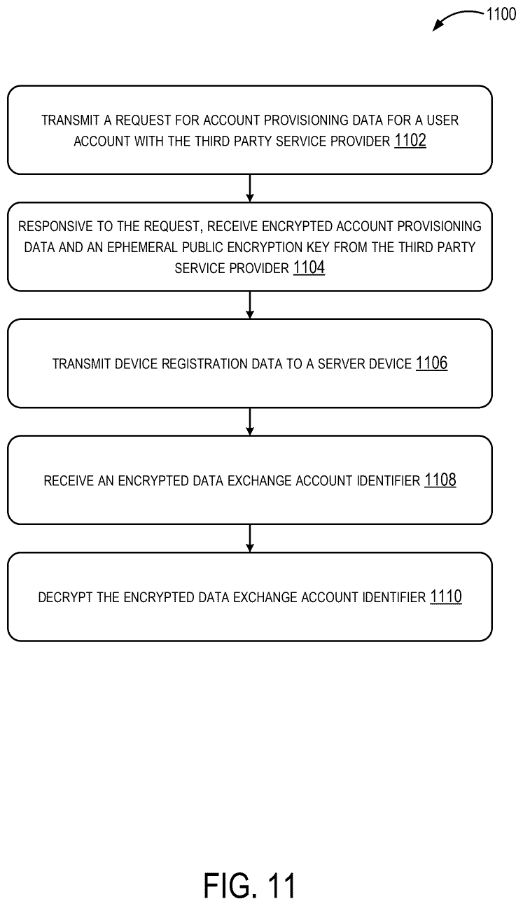

FIG. 10 illustrates an example process 1000 for validating and relaying a push model data exchange payload from a user device by a server device, according to some embodiments. The process 1000 may be performed by an application (e.g., server application 660 of FIG. 6).

The process 1000 can begin at block 1002 with the application receiving an encrypted data exchange payload from a user device. The encrypted data exchange payload can include a data exchange account identifier associated with the user device. For example, the data exchange account identifier can correspond to an account with a real time payments service provider.

At block 1004, the application can validate the encrypted data exchange payload using the data exchange account identifier. For example, the encrypted data exchange payload may be signed by an application executing at the user device. The application at the server device can verify the signature using the data exchange account identifier to confirm that the encrypted data exchange payload was generated at the user device.

At block 1006, the application can transmit the encrypted data exchange payload to a third-party computer system. The application can transmit the encrypted data exchange payload based in part on successfully validating the encrypted data exchange payload. In some embodiments, transmitting the encrypted data exchange payload to the third-party computer system can initiate a data exchange between a first computer system and a second computer system associated with a data exchange account associated with the user device. The data exchange can be a real time payment transaction, so that the third-party computer system is a real time payments network.

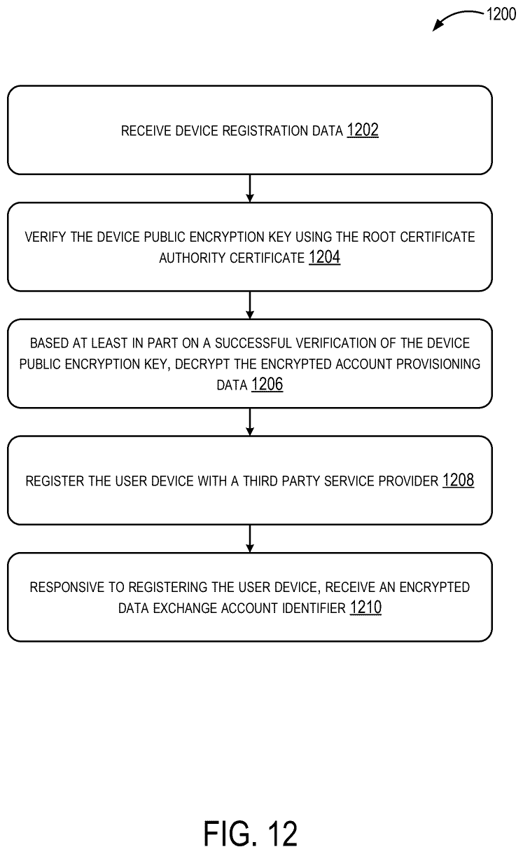

FIG. 11 illustrates an example process 1100 for provisioning a data exchange account at a user device, according to some embodiments. The process 1100 can be performed by one or more applications executing on the user device (e.g., user device 502 of FIG. 5), including a third-party application (e.g., third-party application 504 of FIG. 5), a data exchange application (e.g., data exchange application 506 of FIG. 5), and an applet executing at a secure component of the user device (e.g., secure component 508 of FIG. 5). Some of the operations of process 1100 may be similar to operations described above with respect to data flow 500 of FIG. 5.

The process 1100 may begin at block 1102, with the user device transmitting a request for account provisioning data to a third-party service provider. The request can be for a user account with the third-party service provider. For example, the user device can request account provisioning data usable by the third-party application and the data exchange application to provision a data exchange account at the user device and register the user device with the third-party service provider in a secure manner. The request may be sent in response to user input at the user device. For example, a user can interact with the third-party application to initiate provisioning the user account at the user device. In some embodiments, the request can include information usable for both encryption and verification operations at the third-party service provider. For example, the request can include a public key certificate for a server device that can subsequently be used in the provisioning process. The request can also include a nonce or other token generated by the user device.

At block 1104, the user device can receive encrypted account provisioning data and an ephemeral public encryption key from the third-party service provider. The encrypted account provisioning data and the ephemeral public encryption key can be received in response to sending the request. The ephemeral public encryption key can correspond to the third-party service provider. For example, the third-party service provider can generate an ephemeral key pair including an ephemeral public encryption key and an ephemeral private encryption key.

In some embodiments, prior to transmitting the request, the user device can obtain from a server device a public certificate. The public certificate can be a certificate including a public key corresponding to the server device. The user device can transmit the public certificate to the third-party service provider with the request. The public certificate can be used by the third-party service provider to generate the encrypted account provisioning data. For example, the third-party service provider can derive an encryption key using the ephemeral private encryption key and the public key in the request to encrypt the account provisioning data.

At block 1106, the user device can transmit device registration data to a server device. The device registration data can include the encrypted account provisioning data, the ephemeral public encryption key, and a device public encryption key. The server device can be configured to both decrypt the encrypted account provisioning data using the ephemeral public encryption key and register the user device with the third-party service provider using the device registration data. Registering the device can include the server device transmitting the device public encryption key to the third-party service provider for use when providing an encrypted data exchange account identifier to the user device in a secure fashion without the server device able to decrypt the data exchange account identifier.

In some embodiments, prior to transmitting the device registration data, the user device can generate the device public encryption key and the device private encryption key (e.g., as a device encryption key pair). The user device can generate a device public encryption key attestation using a root certificate authority certificate. In some embodiments, the device registration data can include the device public encryption key attestation and/or the root certificate authority certificate.

At block 1108, the user device can receive an encrypted data exchange account identifier from the server device. T encrypted data exchange account identifier can be encrypted by the third-party service provider using the device public encryption key.

At block 1110, the user device can use a device private encryption key to decrypt the encrypted data exchange account identifier. The user device can store the data exchange account identifier at a secure component of the user device. In some embodiments, the user device can receive an indication that the user device registration was successful from the server device. In response, the user device can activate the data exchange account at the user device by at least updating an application (e.g., data exchange application) of the one or more applications.

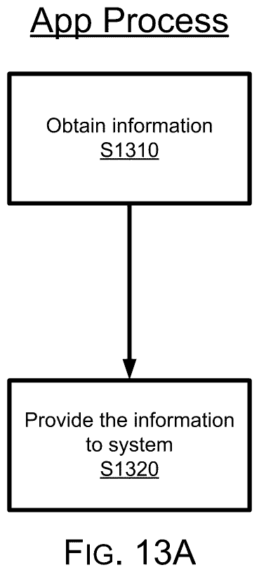

FIG. 12 illustrates an example process 1200 for provisioning a data exchange account using a server device to verify device keys generated by the user device, according to some embodiments. The process 1200 can be performed by an application executing on the server device (e.g., server application 760 of FIG. 7) Some of the operations of process 1200 may be similar to operations described above with respect to data flow 500 of FIG. 5.

The process 1200 can begin at block 1202 with the server device receiving device registration data from a user device. The device registration data can include encrypted account provisioning data, an ephemeral public encryption key, a device public encryption key, and a root certificate authority certificate.

At block 1204, the server device can verify the device public encryption key using the root certificate authority certificate. For example, the device public encryption key may have a corresponding key attestation generated by a secure component of the user device using the root certificate authority certificate. The server device can use the root certificate authority certificate to verify the key attestation was generated with the root certificate authority certificate. In some embodiments, prior to verifying the device public encryption key, the server device verify a chain of trust for the root certificate authority certificate by verifying an identity of the root certificate authority.

At block 1206, if the device public encryption key is successfully verified, the server device can decrypt the encrypted account provisioning data using the ephemeral public encryption key to produce account provisioning data. The account provisioning data can include an account identifier usable by a third-party service provider to associate device keys with an account of the third-party service provider. In some embodiments, the account provisioning data can include a nonce or other token previously generated by the server device and signed by the user device. The server device can use the nonce received with the device registration data to verify the user device in the provisioning process.

At block 1208, the server device can register the user device with a third-party service provider by at least transmitting the account provisioning data, the device public encryption key, and the root certificate authority certificate to the third-party service provider.

At block 1210, in response to registering the user device, the server device can receive, an encrypted data exchange account identifier from the third-party service provider. The data exchange account identifier can be generated by the third-party service provider and then encrypted using a key derived from the device public encryption key and a private key for the third-party service provider. In some embodiments, the server device can transmit the encrypted data exchange account identifier to the user device.

In some embodiments, the server device may not store either the account provisioning data or the encrypted data exchange account identifier. As discussed above with respect to data flow 500 of FIG. 5, the server device may not be able to decrypt the encrypted data exchange account identifier because the decryption requires both the public key for the third-party service provider and the device private encryption key that is securely stored at the user device. In this way, the data exchange account identifier that is usable to initiate data exchange transactions can be securely provided to the user device such that the server device, which verifies the identity of the user device during the provisioning process, is not able to store or access the data exchange account identifier.

Implementations within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, widgets, processes, software, and/or components.

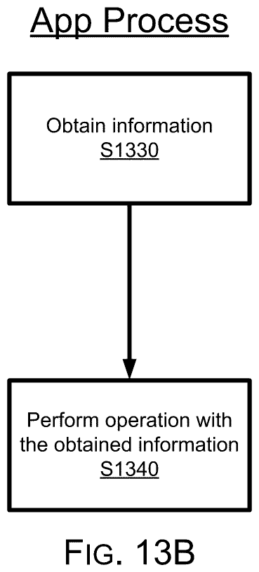

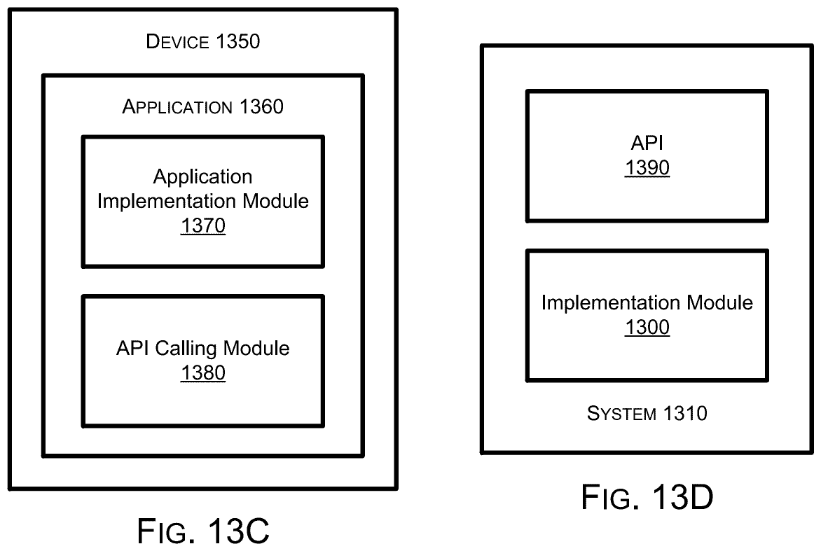

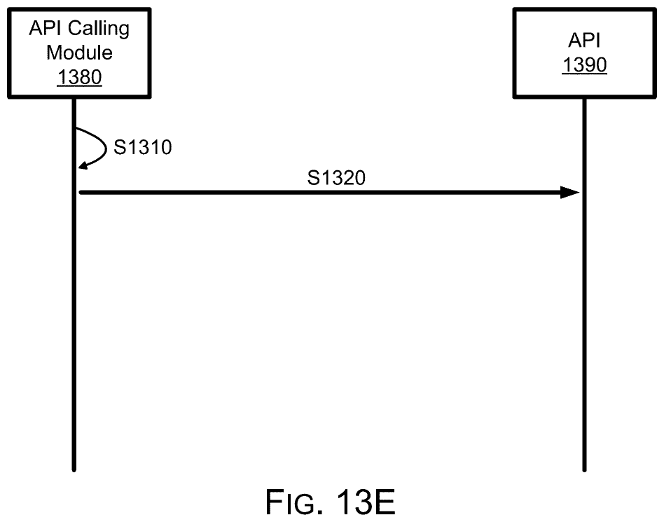

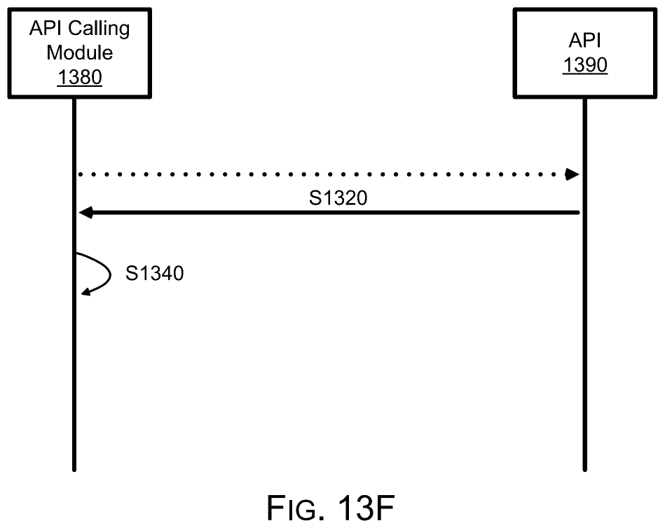

Implementations within the scope of the present disclosure include a computer-readable storage medium that encodes instructions organized as an application (e.g., application 1360) that, when executed by one or more processing units, control an electronic device (e.g., device 1350) to perform the method of FIG. 13A, the method of FIG. 13B, and/or one or more other processes and/or methods described herein.

It should be recognized that application 1360 (shown in FIG. 13C) can be any suitable type of application, including, for example, one or more of: an accessory companion application, a browser application, an application that functions as an execution environment for plug-ins, widgets or other applications, a fitness application, a health application, a digital payments application, a media application, a social network application, a messaging application, and/or a maps application. In some embodiments, application 1360 is an application that is pre-installed on device 1350 at purchase (e.g., a first party application). In other embodiments, application 1360 is an application that is provided to device 1350 via an operating system update file (e.g., a first party application or a second party application). In other embodiments, application 1360 is an application that is provided via an application store. In some embodiments, the application store can be an application store that is pre-installed on device 1350 at purchase (e.g., a first party application store). In other embodiments, the application store is a third-party application store (e.g., an application store that is provided by another application store, downloaded via a network, and/or read from a storage device).

Referring to FIG. 13A and FIG. 13E, application 1360 obtains information (e.g., S1310). In some embodiments, at S1310, information is obtained from at least one hardware component of the device 1350. In some embodiments, at S1310, information is obtained from at least one software module of the device 1350. In some embodiments, at S1310, information is obtained from at least one hardware component external to the device 1350 (e.g., a peripheral device, an accessory device, a server, etc.). In some embodiments, the information obtained at S1310 includes positional information, time information, notification information, user information, environment information, electronic device state information, weather information, media information, historical information, event information, hardware information, and/or motion information. In some embodiments, in response to and/or after obtaining the information at S1310, application 1360 provides the information to a system (e.g., S1320).

In some embodiments, the system (e.g., 1310 shown in FIG. 13D) is an operating system hosted on the device 1350. In some embodiments, the system (e.g., 1310 shown in FIG. 13D) is an external device (e.g., a server, a peripheral device, an accessory, a personal computing device, etc.) that includes an operating system.

Referring to FIG. 13B and FIG. 13F, application 1360 obtains information (e.g., S1330). In some embodiments, the information obtained at S1330 includes positional information, time information, notification information, user information, environment information electronic device state information, weather information, media information, historical information, event information, hardware information and/or motion information. In response to and/or after obtaining the information at S1330, application 1360 performs an operation with the information (e.g., S1340). In some embodiments, the operation performed at S1340 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 1310 based on the information.

In some embodiments, one or more steps of the method of FIG. 13A and/or the method of FIG. 13B is performed in response to a trigger. In some embodiments, the trigger includes detection of an event, a notification received from system 1310, a user input, and/or a response to a call to an API provided by system 1310.

In some embodiments, the instructions of application 1360, when executed, control device 1350 to perform the method of FIG. 13A and/or the method of FIG. 13B by calling an application programming interface (API) (e.g., API 1390) provided by system 1310. In some embodiments, application 1360 performs at least a portion of the method of FIG. 13A and/or the method of FIG. 13B without calling API 1390.

In some embodiments, one or more steps of the method of FIG. 13A and/or the method of FIG. 13B includes calling an API (e.g., API 1390) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 13C, device 1350 is illustrated. In some embodiments, device 1350 is a personal computing device, a smart phone, a smart watch, a fitness tracker, a head mounted display (HMD) device, a media device, a communal device, a speaker, a television, and/or a tablet. As illustrated in FIG. 13C, device 1350 includes application 1360 and operating system (e.g., system 1310 shown in FIG. 13D). Application 1360 includes application implementation module 1370 and API calling module 1380. System 1310 includes API 1390 and implementation module 1300. It should be recognized that device 1350, application 1360, and/or system 1310 can include more, fewer, and/or different components than illustrated in FIGS. 13C and 13D.

In some embodiments, application implementation module 1370 includes a set of one or more instructions corresponding to one or more operations performed by application 1360. For example, when application 1360 is a messaging application, application implementation module 1370 can include operations to receive and send messages. In some embodiments, application implementation module 1370 communicates with API calling module to communicate with system 1310 via API 1390 (shown in FIG. 13D).

In some embodiments, API 1390 is a software module (e.g., a collection of computer-readable instructions) that provides an interface that allows a different module (e.g., API calling module 1380) to access and/or use one or more functions, methods, procedures, data structures, classes, and/or other services provided by implementation module 1300 of system 1310. For example, API-calling module 1380 can access a feature of implementation module 1300 through one or more API calls or invocations (e.g., embodied by a function or a method call) exposed by API 1390 and can pass data and/or control information using one or more parameters via the API calls or invocations. In some embodiments, API 1390 allows application 1360 to use a service provided by a Software Development Kit (SDK) library. In other embodiments, application 1360 incorporates a call to a function or method provided by the SDK library and provided by API 1390 or uses data types or objects defined in the SDK library and provided by API 1390. In some embodiments, API-calling module 1380 makes an API call via API 1390 to access and use a feature of implementation module 1300 that is specified by API 1390. In such embodiments, implementation module 1300 can return a value via API 1390 to API-calling module 1380 in response to the API call. The value can report to application 1360 the capabilities or state of a hardware component of device 1350, including those related to aspects such as input capabilities and state, output capabilities and state, processing capability, power state, storage capacity and state, and/or communications capability. In some embodiments, API 1390 is implemented in part by firmware, microcode, or other low level logic that executes in part on the hardware component.

In some embodiments, API 1390 allows a developer of API-calling module 1380 (which can be a third-party developer) to leverage a feature provided by implementation module 1300. In such embodiments, there can be one or more API-calling modules (e.g., including API-calling module 1380) that communicate with implementation module 1300. In some embodiments, API 1390 allows multiple API-calling modules written in different programming languages to communicate with implementation module 1300 (e.g., API 1390 can include features for translating calls and returns between implementation module 1300 and API-calling module 1380) while API 1390 is implemented in terms of a specific programming language. In some embodiments, API-calling module 1380 calls APIs from different providers such as a set of APIs from an OS provider, another set of APIs from a plug-in provider, and/or another set of APIs from another provider (e.g., the provider of a software library) or creator of the another set of APIs.

Examples of API 1390 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a bluetooth API, an NFC API, a UWB API, a fitness API, a smart home API, contact transfer API, photos API, camera API, and/or image processing API. In some embodiments the sensor API is an API for accessing data associated with a sensor of device 1350. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation module 1300 is a system (e.g., operating system, server system) software module (e.g., a collection of computer-readable instructions) that is constructed to perform an operation in response to receiving an API call via API 1390. In some embodiments, implementation module 1300 is constructed to provide an API response (via API 1390) as a result of processing an API call. By way of example, implementation module 1300 and API-calling module 1380 can each be any one of an operating system, a library, a device driver, an API, an application program, or other module. It should be understood that implementation module 1300 and API-calling module 1380 can be the same or different type of module from each other. In some embodiments, implementation module 1300 is embodied at least in part in firmware, microcode, or other hardware logic.

In some embodiments, implementation module 1300 returns a value through API 1390 in response to an API call from API-calling module 1380. While API 1390 defines the syntax and result of an API call (e.g., how to invoke the API call and what the API call does), API 1390 might not reveal how implementation module 1300 accomplishes the function specified by the API call. Various API calls are transferred via the one or more application programming interfaces between API-calling module 1380 and implementation module 1300. Transferring the API calls can include issuing, initiating, invoking, calling, receiving, returning, and/or responding to the function calls or messages. In other words, transferring can describe actions by either of API-calling module 1380 or implementation module 1300. In some embodiments, a function call or other invocation of API 1390 sends and/or receives one or more parameters through a parameter list or other structure.

In some embodiments, implementation module 1300 provides more than one API, each providing a different view of or with different aspects of functionality implemented by implementation module 1300. For example, one API of implementation module 1300 can provide a first set of functions and can be exposed to third-party developers, and another API of implementation module 1300 can be hidden (e.g., not exposed) and provide a subset of the first set of functions and also provide another set of functions, such as testing or debugging functions which are not in the first set of functions. In some embodiments, implementation module 1300 calls one or more other components via an underlying API and thus be both an API calling module and an implementation module. It should be recognized that implementation module 1300 can include additional functions, methods, classes, data structures, and/or other features that are not specified through API 1390 and are not available to API calling module 1380. It should also be recognized that API calling module 1380 can be on the same system as implementation module 1300 or can be located remotely and access implementation module 1300 using API 1390 over a network. In some embodiments, implementation module 1300, API 1390, and/or API-calling module 1380 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

In some embodiments, process 800 of FIG. 8, process 900 of FIG. 9, process 1000 of FIG. 10, process 1100 of FIG. 11, and/or process 1200 of FIG. 12 are performed at a first computer system (as described herein) via a system process (e.g., an operating system process, a server system process) that is different from one or more applications executing and/or installed on the first computer system.

In some embodiments, process 800 of FIG. 8, process 900 of FIG. 9, process 1000 of FIG. 10, process 1100 of FIG. 11, and/or process 1200 of FIG. 12 are performed at a first computer system (as described herein) by an application that is different from a system process. In some embodiments, the instructions of the application, when executed, control the first computer system to perform process 800 of FIG. 8, process 900 of FIG. 9, process 1000 of FIG. 10, process 1100 of FIG. 11, and/or process 1200 of FIG. 12 by calling an application programming interface (API) provided by the system process. In some embodiments, the application performs at least a portion of process 800 of FIG. 8, process 900 of FIG. 9, process 1000 of FIG. 10, process 1100 of FIG. 11, and/or process 1200 of FIG. 12 without calling the API.

In some embodiments, the application is an accessory companion application that is constructed for processing communication and management between the first computer system and an accessory device (e.g., a wearable device, such as, for example, a watch).

In some embodiments, the application is an application that is pre-installed on the first computer system at purchase (e.g., a first party application). In other embodiments, the application is an application that is provided to the first computer system via an operating system update file (e.g., a first party application). In other embodiments, the application is an application that is provided via an application store. In some implementations, the application store is pre-installed on the first computer system at purchase (e.g., a first party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform process 800 of FIG. 8, process 900 of FIG. 9, process 1000 of FIG. 10, process 1100 of FIG. 11, and/or process 1200 of FIG. 12 by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a bluetooth API, an NFC API, a UWB API, a fitness API, a smart home API, contact transfer API, photos API, camera API, and/or image processing API.

In some embodiments, at least one API is a software module (e.g., a collection of computer-readable instructions) that provides an interface that allows a different module (e.g., API calling module) to access and use one or more functions, methods, procedures, data structures, classes, and/or other services provided by an implementation module of the system process. The API can define one or more parameters that are passed between the API calling module and the implementation module. In some embodiments, the API 1390 defines a first API call that can be provided by API calling module 1390. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 1350) that runs the application. In some embodiments, the implementation module is included in an electronic device that is separate from the device that runs the application.

Illustrative methods and devices for using data exchange options in a data exchange session are described above. Some or all of these devices and methods may, but need not, be implemented at least partially by architectures such as those shown at least in FIG. 7. Further, in the foregoing description, various non-limiting examples were described. For purposes of explanation, specific configurations and details are set forth in order to provide a thorough understanding of the examples. However, it should also be apparent to one skilled in the art that the examples may be practiced without the specific details. Furthermore, well-known features were sometimes omitted or simplified in order not to obscure the example being described.

The various examples further can be implemented in a wide variety of operating environments, which in some cases can include one or more user computers, computing devices or processing devices which can be used to operate any of a number of applications. User or client devices can include any of a number of general purpose personal computers, such as desktop or laptop computers running a standard operating system, as well as cellular, wireless and handheld devices running mobile software and capable of supporting a number of networking and messaging protocols. Such a system also can include a number of workstations running any of a variety of commercially available operating systems and other known applications for purposes such as development and database management. These devices also can include other electronic devices, such as dummy terminals, thin-clients, gaming systems, and other devices capable of communicating via a network.

Most examples utilize at least one network that would be familiar to those skilled in the art for supporting communications using any of a variety of commercially available protocols, such as TCP/IP, OSI, FTP, UPnP, NFS, CIFS, and AppleTalk. The network can be, for example, a local area network, a wide-area network, a virtual private network, the Internet, an intranet, an extranet, a public switched telephone network, an infrared network, a wireless network, and any combination thereof.

In examples utilizing a network server, the network server can run any of a variety of server or mid-tier applications, including HTTP servers, FTP servers, CGI servers, data servers, Java servers, and business application servers. The server(s) may also be capable of executing programs or scripts in response to requests from user devices, such as by executing one or more applications that may be implemented as one or more scripts or programs written in any programming language, such as Java®, C, C# or C++, or any scripting language, such as Perl, Python or TCL, as well as combinations thereof. The server(s) may also include database servers, including without limitation those commercially available from Oracle®, Microsoft®, Sybase®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of examples, the information may reside in a storage-area network (SAN) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen, or keypad), and at least one output device (e.g., a display device, printer, or speaker). Such a system may also include one or more storage devices, such as disk drives, optical storage devices, and solid-state storage devices such as RAM or ROM, as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a non-transitory computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or browser. It should be appreciated that alternate examples may have numerous variations from that described above. For example, customized hardware might also be used and/or particular elements might be implemented in hardware, software (including portable software, such as applets) or both. Further, connection to other computing devices such as network input/output devices may be employed.

Non-transitory storage media and computer-readable media for containing code, or portions of code, can include any appropriate media known or used in the art, including storage media, such as, but not limited to, volatile and non-volatile, removable and non-removable media implemented in any method or technology for storage of information such as computer-readable instructions, data structures, program modules, or other data, including RAM, ROM, EEPROM, flash memory or other memory technology, CD-ROM, DVD or other optical storage, magnetic cassettes, magnetic tape, magnetic disk storage or other magnetic storage devices, or any other medium which can be used to store the desired information and which can be accessed by a system device. Based at least in part on the disclosure and teachings provided herein, a person of ordinary skill in the art will appreciate other ways and/or methods to implement the various examples.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated examples thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed examples (especially in the context of the following claims) are to be construed to cover both the singular and the plural, unless otherwise indicated herein or clearly contradicted by context. The terms “comprising,” “having,” “including,” and “containing” are to be construed as open-ended terms (e.g., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate examples of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present.

Preferred examples of this disclosure are described herein, including the best mode known to the inventors for carrying out the disclosure. Variations of those preferred examples may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

As described above, one aspect of the present technology is the gathering and use of data to improve the functioning of data exchange between user devices and various third-party devices including terminal devices. The present disclosure contemplates that in some instances, this gathered data may include personally identifiable information (PII) data that uniquely identifies or can be used to contact or locate a specific person. Such personal information data can include demographic data, location-based data (e.g., GPS coordinates), telephone numbers, email addresses, Twitter ID's, home addresses, or any other identifying or personal information.

The present disclosure recognizes that the use of such personal information data, in the present technology, can be used to the benefit of users. For example, the personal information data can be used to obtain access to an application for locating peripheral devices associated with a user, user account, or a user device.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of services related to tracking a user's location (e.g., via the user's mobile device), the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

As described herein, content is automatically generated by one or more computers in response to a request to generate the content. The automatically-generated content is optionally generated on-device (e.g., generated at least in part by a computer system at which a request to generate the content is received) and/or generated off-device (e.g., generated at least in part by one or more nearby computers that are available via a local network or one or more computers that are available via the internet). This automatically-generated content optionally includes visual content (e.g., images, graphics, and/or video), audio content, and/or text content.

In some embodiments, novel automatically-generated content that is generated via one or more artificial intelligence (AI) processes is referred to as generative content (e.g., generative images, generative graphics, generative video, generative audio, and/or generative text). Generative content is typically generated by an AI process based on a prompt that is provided to the AI process. An AI process typically uses one or more AI models to generate an output based on an input. An AI process optionally includes one or more pre-processing steps to adjust the input before it is used by the AI model to generate an output (e.g., adjustment to a user-provided prompt, creation of a system-generated prompt, and/or AI model selection). An AI process optionally includes one or more post-processing steps to adjust the output by the AI model (e.g., passing AI model output to a different AI model, upscaling, downscaling, cropping, formatting, and/or adding or removing metadata) before the output of the AI model used for other purposes such as being provided to a different software process for further processing or being presented (e.g., visually or audibly) to a user. An AI process that generates generative content is sometimes referred to as a generative AI process.

A prompt for generating generative content can include one or more of: one or more words (e.g., a natural language prompt that is written or spoken), one or more images, one or more drawings, and/or one or more videos. AI processes can include machine learning models including neural networks. Neural networks can include transformer-based deep neural networks such as large language models (LLMs). Generative pre-trained transformer models are a type of LLM that can be effective at generating novel generative content based on a prompt. Some AI processes use a prompt that includes text to generate either different generative text, generative audio content, and/or generative visual content. Some AI processes use a prompt that includes visual content and/or an audio content to generate generative text (e.g., a transcription of audio and/or a description of the visual content). Some multi-modal AI processes use a prompt that includes multiple types of content (e.g., text, images, audio, video, and/or other sensor data) to generate generative content. A prompt sometimes also includes values for one or more parameters indicating an importance of various parts of the prompt. Some prompts include a structured set of instructions that can be understood by an AI process that include phrasing, a specified style, relevant context (e.g., starting point content and/or one or more examples), and/or a role for the AI process.

Generative content is generally based on the prompt but is not deterministically selected from pre-generated content and is, instead, generated using the prompt as a starting point. In some embodiments, pre-existing content (e.g., audio, text, and/or visual content) is used as part of the prompt for creating generative content (e.g., the pre-existing content is used as a starting point for creating the generative content). For example, a prompt could request that a block of text be summarized or rewritten in a different tone, and the output would be generative text that is summarized or written in the different tone. Similarly a prompt could request that visual content be modified to include or exclude content specified by a prompt (e.g., removing an identified feature in the visual content, adding a feature to the visual content that is described in a prompt, changing a visual style of the visual content, and/or creating additional visual elements outside of a spatial or temporal boundary of the visual content that are based on the visual content). In some embodiments, a random or pseudo-random seed is used as part of the prompt for creating generative content (e.g., the random or pseud-random seed content is used as a starting point for creating the generative content). For example, when generating an image from a diffusion model, a random noise pattern is iteratively denoised based on the prompt to generate an image that is based on the prompt. While specific types of AI processes have been described herein, it should be understood that a variety of different AI processes could be used to generate generative content based on a prompt.

Some embodiments described herein can include use of artificial intelligence and/or machine learning systems (sometimes referred to herein as the AI/ML systems). The use can include collecting, processing, labeling, organizing, analyzing, recommending and/or generating data. Entities that collect, share, and/or otherwise utilize user data should provide transparency and/or obtain user consent when collecting such data. The present disclosure recognizes that the use of the data in the AI/ML systems can be used to benefit users. For example, the data can be used to train models that can be deployed to improve performance, accuracy, and/or functionality of applications and/or services. Accordingly, the use of the data enables the AI/ML systems to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the AI/ML systems are also contemplated by the present disclosure.

The present disclosure contemplates that, in some embodiments, data used by AI/ML systems includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with AI/ML systems, should attempt to comply with well-established privacy policies and/or privacy practices.

For example, such entities may implement and consistently follow policies and practices recognized as meeting or exceeding industry standards and regulatory requirements for developing and/or training AI/ML systems. In doing so, attempts should be made to ensure all intellectual property rights and privacy considerations are maintained. Training should include practices safeguarding training data, such as personal information, through sufficient protections against misuse or exploitation. Such policies and practices should cover all stages of the AI/ML systems development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In some embodiments, AI/ML systems may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other implementations, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In some embodiments, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of increased computational resources of the other devices to train and execute the ML model. Accordingly, user-collected data can be protected. In some implementations, data from multiple devices can be combined in a privacy-preserving manner to train an ML model.

In some embodiments, the present disclosure contemplates that data used for AI/ML systems may be kept strictly separated from platforms where the AI/ML systems are deployed and/or used to interact with users and/or process data. In such embodiments, data used for offline training of the AI/ML systems may be maintained in secured datastores with restricted access and/or not be retained beyond the duration necessary for training purposes. In some embodiments, the AI/ML systems may utilize a local memory cache to store data temporarily during a user session. The local memory cache may be used to improve performance of the AI/ML systems. However, to protect user privacy, data stored in the local memory cache may be erased after the user session is completed. Any temporary caches of data used for online learning or inference may be promptly erased after processing. All data collection, transfer, and/or storage should use industry-standard encryption and/or secure communication.

In some embodiments, as noted above, techniques such as federated learning, differential privacy, secure hardware components, homomorphic encryption, and/or multi-party computation among other techniques may be utilized to further protect personal information data during training and/or use of the AI/ML systems. The AI/ML systems should be monitored for changes in underlying data distribution such as concept drift or data skew that can degrade performance of the AI/ML systems over time.

In some embodiments, the AI/ML systems are trained using a combination of offline and online training. Offline training can use curated datasets to establish baseline model performance, while online training can allow the AI/ML systems to continually adapt and/or improve. The present disclosure recognizes the importance of maintaining strict data governance practices throughout this process to ensure user privacy is protected.

In some embodiments, the AI/ML systems may be designed with safeguards to maintain adherence to originally intended purposes, even as the AI/ML systems adapt based on new data. Any significant changes in data collection and/or applications of an AI/ML system use may (and in some cases should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the AI/ML systems and/or for use as input during the inference stage of such systems. In yet another example, the present technology should be configured to allow users to be able to select to limit the length of time data is maintained or entirely prohibit the use of their data for use by the AI/ML systems. In addition to providing “opt in” and “opt out” options, the present disclosure contemplates providing notifications relating to the access or use of personal information. For instance, a user can be notified when their data is being input into the AI/ML systems for training or inference purposes, and/or reminded when the AI/ML systems generate outputs or make decisions based on their data.

The present disclosure recognizes AI/ML systems should incorporate explicit restrictions and/or oversight to mitigate against risks that may be present even when such systems having been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to third-party products and/or services in the outputs should not be construed as endorsements or affiliations by the entities providing the AI/ML systems. Generated content can be filtered for potentially inappropriate or dangerous material prior to being presented to users, while human oversight and/or ability to override or correct erroneous or undesirable outputs can be maintained as a failsafe.

The present disclosure further contemplates that users of the AI/ML systems should refrain from using the services in any manner that infringes upon, misappropriates, or violates the rights of any party. Furthermore, the AI/ML systems should not be used for any unlawful or illegal activity, nor to develop any application or use case that would commit or facilitate the commission of a crime, or other tortious, unlawful, or illegal act. The AI/ML systems should not violate, misappropriate, or infringe any copyrights, trademarks, rights of privacy and publicity, trade secrets, patents, or other proprietary or legal rights of any party, and appropriately attribute content as required. Further, the AI/ML systems should not interfere with any security, digital signing, digital rights management, content protection, verification, or authentication mechanisms. The AI/ML systems should not misrepresent machine-generated outputs as being human-generated.

All references, including publications, patent applications, and patents, cited herein are hereby incorporated by reference to the same extent as if each reference were individually and specifically indicated to be incorporated by reference and were set forth in its entirety herein.

What is claimed is:

1. A method performed by one or more applications executing on a user device, the method comprising:
transmitting, to a third-party service provider, a request for account provisioning data for a user account with the third-party service provider;
responsive to the request, receiving encrypted account provisioning data and an ephemeral public encryption key from the third-party service provider, the ephemeral public encryption key corresponding to the third-party service provider;
transmitting device registration data to a server device, the device registration data comprising the encrypted account provisioning data, the ephemeral public encryption key, and a device public encryption key, the server device configured to (i) decrypt the encrypted account provisioning data using the ephemeral public encryption key and (ii) register the user device with the third-party service provider using the device registration data;
receiving, from the server device, an encrypted data exchange account identifier, the encrypted data exchange account identifier encrypted using the device public encryption key; and
decrypting, using a device private encryption key, the encrypted data exchange account identifier.

2. The method of claim 1, further comprising storing the data exchange account identifier at a secure component of the user device.

3. The method of claim 1, further comprising:
receiving, from the server device, an indication that the user device registration was successful; and
responsive to the indication, activating the data exchange account at the user device by at least updating an application of the one or more applications.

4. The method of claim 1, further comprising:
prior to transmitting the request, obtaining, from the server device, a public certificate; and
transmitting the public certificate to the third-party service provider with the request, the public certificate usable by the third-party service provider to generate the encrypted account provisioning data.

5. The method of claim 1, further comprising:
prior to transmitting the device registration data, generating the device public encryption key and the device private encryption key; and
generating, using a root certificate authority certificate, a device public encryption key attestation.

6. The method of claim 5, wherein the device registration data further comprises the device public encryption key attestation.

7. The method of claim 5, wherein the device registration data further comprises the root certificate authority certificate.

8. A user device, comprising:
one or more processors; and
one or more memories storing computer-executable instructions that, when executed by the one or more processors, cause the user device to execute one or more applications configured to at least:
transmit, to a third-party service provider, a request for account provisioning data for a user account with the third-party service provider;
responsive to the request, receive encrypted account provisioning data and an ephemeral public encryption key from the third-party service provider, the ephemeral public encryption key corresponding to the third-party service provider;
transmit device registration data to a server device, the device registration data comprising the encrypted account provisioning data, the ephemeral public encryption key, and a device public encryption key, the server device configured to (i) decrypt the encrypted account provisioning data using the ephemeral public encryption key and (ii) register the user device with the third-party service provider using the device registration data;
receive, from the server device, an encrypted data exchange account identifier, the encrypted data exchange account identifier encrypted using the device public encryption key; and
decrypt, using a device private encryption key, the encrypted data exchange account identifier.

9. The user device of claim 8, wherein the one or more applications are further configured to store the data exchange account identifier at a secure component of the user device.

10. The user device of claim 8, wherein the one or more applications are further configured to:
receive, from the server device, an indication that the user device registration was successful; and
responsive to the indication, activate the data exchange account at the user device by at least updating an application of the one or more applications.

11. The user device of claim 8, wherein the one or more applications are further configured to:
prior to transmitting the request, obtain, from the server device, a public certificate; and
transmit the public certificate to the third-party service provider with the request, the public certificate usable by the third-party service provider to generate the encrypted account provisioning data.

12. The user device of claim 8, wherein the one or more applications are further configured to:
prior to transmitting the device registration data, generate the device public encryption key and the device private encryption key; and
generate, using a root certificate authority certificate, a device public encryption key attestation.

13. The user device of claim 12, wherein the device registration data further comprises the device public encryption key attestation.

14. The user device of claim 12, wherein the device registration data further comprises the root certificate authority certificate.

15. One or more computer-readable media storing computer-executable instructions that, when executed by one or more processors of a user device, cause the one or more processors to execute one or more applications configured to at least:
transmit, to a third-party service provider, a request for account provisioning data for a user account with the third-party service provider;
responsive to the request, receive encrypted account provisioning data and an ephemeral public encryption key from the third-party service provider, the ephemeral public encryption key corresponding to the third-party service provider;
transmit device registration data to a server device, the device registration data comprising the encrypted account provisioning data, the ephemeral public encryption key, and a device public encryption key, the server device configured to (i) decrypt the encrypted account provisioning data using the ephemeral public encryption key and (ii) register the user device with the third-party service provider using the device registration data;
receive, from the server device, an encrypted data exchange account identifier, the encrypted data exchange account identifier encrypted using the device public encryption key; and
decrypt, using a device private encryption key, the encrypted data exchange account identifier.

16. The one or more computer-readable media of claim 15, wherein the one or more applications are further configured to store the data exchange account identifier at a secure component of the user device.

17. The one or more computer-readable media of claim 15, wherein the one or more applications are further configured to:
receive, from the server device, an indication that the user device registration was successful; and
responsive to the indication, activate the data exchange account at the user device by at least updating an application of the one or more applications.

18. The one or more computer-readable media of claim 15, wherein the one or more applications are further configured to:
prior to transmitting the request, obtain, from the server device, a public certificate; and
transmit the public certificate to the third-party service provider with the request, the public certificate usable by the third-party service provider to generate the encrypted account provisioning data.

19. The one or more computer-readable media of claim 15, wherein the one or more applications are further configured to:
prior to transmitting the device registration data, generate the device public encryption key and the device private encryption key; and
generate, using a root certificate authority certificate, a device public encryption key attestation.

20. The one or more computer-readable media of claim 19, wherein the device registration data further comprises the device public encryption key attestation.
